(19) United States
(12) Patent Application Publication
(10) Pub. No.: US 2026/0075399 A1
(43) Pub. Date: Mar. 12, 2026

(54) METHOD AND APPARATUS FOR POWER MANAGEMENT IN A USER EQUIPMENT (UE) FACILITATING PLURALITY OF SIMS

(71) Applicant: SAMSUNG ELECTRONICS CO., LTD., Suwon-si (KR)

(72) Inventors: Aman AGARWAL, Bangalore (IN); Kailash Kumar Jha, Bangalore (IN); Nishant, Bangalore (IN); Sidhant Jain, Bangalore (IN); Lalith Kumar, Bangalore (IN)

(73) Assignee: SAMSUNG ELECTRONICS CO., LTD., Suwon-si (KR)

(21) Appl. No.: 19/242,051

(22) Filed: Jun. 18, 2025

(30) Foreign Application Priority Data
Sep. 12, 2024 (IN) 202441069137

(51) Int. Cl. H04W 8/00; H04W 8/18; H04W 64/00; H04W 84/06

(52) U.S. Cl. CPC H04W 8/005; H04W 8/183; H04W 64/00; H04W 84/06

(57) ABSTRACT

A method of power management in a User Equipment (UE) including a plurality of Subscriber Identity Modules (SIMs), includes: enabling, by the UE, one of plurality of SIMs as a primary SIM when the UE is in a location with no Terrestrial Network (TN) coverage, wherein the primary SIM performs a scanning for availability of the TN coverage; disabling, by the UE, one or more of the plurality of SIMs while the primary SIM scans for the TN coverage, wherein the one or more of the plurality of SIMs are different from the primary SIM; and enabling, by the UE, the one or more of the plurality of SIMs of the UE, based on detecting the availability of the TN coverage in response to the scanning performed by the primary SIM.

### CROSS-REFERENCE TO RELATED APPLICATIONS

This application is based on and claims priority under 35 U.S.C. § 119 to Indian Complete patent application No. 202441069137, filed on Sep. 12, 2024, in the Indian Patent Office, the disclosure of which is incorporated by reference herein in its entirety.

### BACKGROUND

### 1. Field

The present disclosure relates, in general, to wireless communication networks. Particularly, the present disclosure relates to a method of power management in a User Equipment (UE) including or facilitating plurality of subscriber identity modules (SIMs).

### 2. Description of Related Art

In recent years, various network services for Terrestrial Networks (TN) are used to provide high network services to users. Examples of the various network services for TN include landlines, Wireless Fidelity (WiFi), Long Term Evolution (LTE), 5^{th} Generation (5G), wireless transmission systems and the like. However, in remote areas, these TN services may not be available. In order to solve the aforementioned problem of providing the network services in remote areas, Non-Terrestrial Network (NTN) devices, such as satellites, are used by network operators to provide the network services in remote areas where the TN coverage is not extensive.

Devices include SIMs that support both NTN and TN services and that get access to the TN services and the NTN services. The devices may scan for the respective TN and NTN bands and frequencies. In such scenarios, when a user equipment (UE) is in remote or unpopulated areas where TN coverage is not extensive, the UE constantly scans for TN coverage even after the UE determines unavailability of TN coverage multiple times, which results in faster draining of the UE's power.

Furthermore, some countries may not allow NTN services from operators not belonging to that country in some parts of that country due to regulatory reasons. In such scenarios, the UE constantly searches for NTN coverage even after receiving a reject cause indicating unavailability of network services for the UE in the region leading to more power consumption resulting in faster draining of the battery of the UE. This faster draining of the battery further results in poor user experience.

Therefore, there is a need for an improved method of power management in a UE including a plurality of SIMs.

The information disclosed in this background of the disclosure section is only for enhancement of understanding of the general background of the present disclosure and should not be taken as an acknowledgement or any form of suggestion that this information forms the related art already known to a person skilled in the art.

### SUMMARY

Provided is a method of power management in a User Equipment (UE) including or facilitating a plurality of Subscriber Identity Modules (SIMs).

According to an aspect of the disclosure, a method of power management in a User Equipment (UE) including a plurality of Subscriber Identity Modules (SIMs), includes: enabling, by the UE, one of plurality of SIMs as a primary SIM when the UE is in a location with no Terrestrial Network (TN) coverage, wherein the primary SIM performs a scanning for availability of the TN coverage; disabling, by the UE, one or more of the plurality of SIMs while the primary SIM scans for the TN coverage, wherein the one or more of the plurality of SIMs are different from the primary SIM; and enabling, by the UE, the one or more of the plurality of SIMs of the UE, based on detecting the availability of the TN coverage in response to the scanning performed by the primary SIM.

According to an aspect of the disclosure, a method of power management in a User Equipment (UE) including a plurality of SIMs, includes: sending, by the UE, a signaling message for one or more of plurality of SIMs of the UE to one or more NTN networks accessible in a current location of the UE for accessing NTN services; receiving, by the UE, a reject cause indicating inability to provide the NTN services in the current location of the UE, from the one or more NTN networks, in response to the signaling for the one or more of the plurality of SIMs of the UE; and disabling, by the UE, the one or more of plurality of SIMs of the UE in response to receiving the reject cause from the one or more NTN networks, until an expiry of at least one preset condition indicated in the corresponding reject cause, wherein the one or more of the plurality of SIMs belong to a location which is same as home location of the one or more of the plurality of SIMs for which the reject cause is received.

According to an aspect of the disclosure, a User Equipment (UE) including a plurality of Subscriber Identity Modules (SIMs) for power management, includes: a processor; a memory, communicatively coupled to the processor, wherein the memory stores instructions, which, on execution, cause the processor to: enable one of plurality of SIMs as a primary SIM when the UE is in a location with no Terrestrial Network (TN) coverage, wherein the primary SIM scans for availability of the TN coverage; disable one or more of the plurality of SIMs while the primary SIM scans for the TN coverage, wherein the one or more of the plurality of SIMs are different from the primary SIM; and enable the one or more of the plurality of SIMs upon detecting the availability of the TN coverage in response to scanning by the primary SIM.

According to an aspect of the disclosure, a User Equipment (UE) including a plurality of SIMs for power management, includes: a processor; a memory, communicatively coupled to the processor, wherein the memory stores instructions, which, on execution, cause the processor to: send a signaling message for one or more of plurality of SIMs to one or more NTN networks accessible in a current location of the UE for accessing NTN services; receive a reject cause indicating inability to provide the NTN services in the current location of the UE, from the one or more NTN networks, in response to the signaling for the one or more of the plurality of SIMs; and disable the one or more of plurality of SIMs in response to receiving the reject cause from the one or more NTN networks, until an expiry of at least one preset condition indicated in the corresponding reject cause, wherein the one or more of the plurality of SIMs belong to a location which is same as home location of the one or more of the plurality of SIMs for which the reject cause is received.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate example embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIGS. 1A-1D show illustrations of exemplary cellular coverage search scenarios in a dual SIM device leading to high power consumption;

FIG. 1E shows an architecture diagram for power management in a User Equipment (UE) including a plurality of Subscriber Identity Modules (SIMs), in accordance with some embodiments of the present disclosure;

FIG. 1F illustrates a scenario depicting unavailability of TN coverage in a new location, in accordance with some embodiments of the present disclosure;

FIG. 2A depicts a detailed block diagram of power management in a UE including a plurality of SIMs, in accordance with some embodiments related to the present disclosure;

FIG. 2B depicts a detailed block diagram of power management in a UE including a plurality of SIMs, in accordance with some embodiments related to the present disclosure;

FIG. 2C-2E illustrates example embodiments illustrating various scenarios of power management in a UE, in accordance with some embodiments related to the present disclosure;

FIG. 2D illustrates a scenario two of power management in a UE, in accordance with some embodiments related to the present disclosure;

FIG. 2E illustrates a scenario three of power management in a UE, in accordance with some embodiments related to the present disclosure;

FIGS. 3A and 3B depict a flowchart illustrating a methods of power management in a UE including a plurality of Subscriber Identity Modules (SIMs), in accordance with some embodiments of the present disclosure; and

FIG. 4 illustrates a block diagram of an exemplary User Equipment (UE) for implementing embodiments consistent with the present disclosure.

Any block diagrams herein represent conceptual views of illustrative systems embodying the principles of the present subject matter. Similarly, any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present disclosure, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and other embodiments may be utilized and that changes may be made without departing from the scope of the present disclosure. The following description is, therefore, not to be taken in a limiting sense.

The following abbreviations and definitions have been referred to herein:
a. 3GPP: Third Generation Partnership Project
b. 5GC: 5G Core
c. 5GCN: 5G Core Network
d. 5G-GUTI: 5G-Globally Unique Temporary Identifier
e. 5GMM: 5G Mobility Management
f. 5GS: 5G System
g. 5GSM: 5GS Session Management
h. 5G-S-TMSI: 5G S-Temporary Mobile Subscription Identifier
i. 5G-TMSI: 5G Temporary Mobile Subscription Identifier
j. AI: Artificial Intelligence
k. AMF: Access and Mobility Management Function
l. AS: Access Stratum
m. BSR: Better System Reselection
n. CAG: Closed access group
o. CAG ID: Closed Access Group Identifier
p. CN: Core Network
q. CU: Centralized Unit
r. DB: Database
s. DC: Discontinuous Coverage
t. DisCo: Discontinuous Coverage
u. DL: Downlink
v. DRX: Discontinuous Reception
w. DU: Distributed Unit
x. eDRX: Extended Discontinuous Reception
y. EHPLMN: Equivalent Home Public Land Mobile Network
z. EMM: EUTRA Mobility Management
aa. eNB: Evolved Node-B
bb. eNPN: Enhanced Non-Public Networks
cc. EPC: Evolved Packet Core
dd. EPLMN: Equivalent Public Land Mobile Network
ee. EPS: Evolved Packet System
ff. eSIM: embedded Subscriber Identity Module
gg. E-UTRA: Evolved Universal Mobile Telecommunication Access
hh. E-UTRAN: Evolved Universal Mobile Telecommunication Access Network
ii. FPLMN: Forbidden Public Land Mobile Network
jj. FR: Frequency Range
kk. GEO: Geostationary Orbit
ll. GERAN: GSM Edge Radio Access Network
mm. GERAN EC-GSM-IoT: GSM Edge Radio Access Network Extended Coverage-GSM-Internet of Things
nn. gNB: Next generation Node-B
oo. gNB-CU: Next generation Node-B Control Unit
pp. gNB-DU: Next generation Node-B Distributive Unit
qq. GPRS: General Packet Radio Service
rr. GSM: Global System for Mobile Communication
ss. HPPLMN: Higher Priority Public Land Mobile Network
tt. HPLMN: Home Public Land Mobile Network
uu. IAB: Integrated access and backhaul
vv. IAB-UE: The part of the IAB node that supports the Uu interface towards the IAB-donor or another parent IAB-node (and thus manages the backhaul connectivity with either PLMN or SNPN it is registered with) is referred to as an IAB-UE.
ww. LADN: Local Area Data Network
xx. LEO: Low Earth Orbit
yy. LRPLMN: Last Registered Public Land Mobile Network
zz. LRPLMNSI: Last Registered PLMN Selection Indication
aaa. LRRAT: Last Registered Radio Access Technology
bbb. MCC: Mobile Country Code
ccc. ME: Mobile Equipment
ddd. MEC: Multi-Access Edge Computing
eee. MEO: Medium Earth Orbit
fff. MICO: Mobile Initiated Communication Only
ggg. ML: Machine Learning
hhh. MME: Mobility Management Entity
iii. MNC: Mobile Network Code
jjj. MPS: Multimedia Priority Service
kkk. MS: Mobile Station. The present disclosure makes no distinction between MS and UE.
lll. NAS: Non-Access Stratum
mmm. NB-S1 Mode: Narrow Band with S1 Interface
nnn. NF: Network Function
ooo. NGAP: Next Generation Application Protocol
ppp. NG-RAN: Next Generation Radio Access Network
qqq. Non-3GPP: Non-3rd Generation Participation Project
rrr. NPN: Non-Public Networks
SSS. NR: New Radio
ttt. NTN: Non-Terrestrial Networks
uuu. NW: Network
vvv. OOS: Out of Service
www. OS Upgrade: Operating System Upgrade
xxx. PDN: Packet Data Network
yyy. PDU: Packet Data Unit
zzz. PLMN ID: Public Land Mobile Network Identity
aaaa. PSM: Power Saving Mode
bbbb. QoS: Quality Of Service
cccc. RAT: Radio Access Technology
dddd. RPLMN: Registered Public Land Mobile Network
eeee. RRC: Radio Resource Control
ffff. RU: Registration Update
gggg. SAT: Satellite
hhhh. Satellite: an artificial body placed in orbit round the earth or moon or another planet in order to collect information or for communication.
iiii. Satellite Constellation: Group of satellites, placed in orbit round the earth or moon or another planet in order to collect information or for communication.
jjjj. SCAF: Satellite Coverage Availability Function
kkkk. SCAI: Satellite Coverage Availability Information
llll. Service User: An individual who has received a priority level assignment from a regional/national authority (i.e., an agency authorised to issue priority assignments) and has a subscription to a mobile network operator
mmmm. SIM: Subscriber Identity Module
nnnn. SMS: Short Messaging Service
oooo. SNPN: Standalone Non-Public Networks
pppp. SUCI: Subscription Concealed Identifier
qqqq. SW: Software
rrrr. TAC: Tracking Area Code
ssss. TAI: Tracking Area Identity
tttt. TAU: Tracking Area Update
uuuu. TER: Terrestrial
vvvv. TN: Terrestrial Networks
wwww. UCU: UE Configuration Update
xxxx. UDM: Unified Data Management Function
yyyy. UE: User Equipment
zzzz. UL: Uplink
aaaaa. ULI: User Location Information
bbbbb. UPU: UE Parameters Update
ccccc. USIM: Universal Subscriber Identification Module
ddddd. Uu: The radio interface between the UE and the Node B
eeeee. VMR: Vehicle Mounted Relay
fffff. VPLMN: Visited Public Land Mobile Network
ggggg. WB-S1 Mode: Wide Band with S1 Interface
hhhhh. Visited PLMN (VPLMN): This is a PLMN different from the HPLMN (if the EHPLMN list is not present or is empty) or different from an EHPLMN (if the EHPLMN list is present).
iiiii. Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.
jjjjj. Available PLMN: PLMN(s) in the given area which is/are broadcasting capability to provide wireless communication services to the UE.
kkkkk. Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.
lllll. EHPLMN: Any of the PLMN entries contained in the Equivalent HPLMN list.
mmmmm. Equivalent HPLMN list: To allow provision for multiple HPLMN codes, PLMN codes that are present within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list then it shall be treated as a Visited PLMN for PLMN selection purposes.
nnnnn. Home PLMN: This is a PLMN where the MCC and MNC of the PLMN identity match the MCC and MNC of the IMSI.
ooooo. Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.
ppppp. Registration: This is the process of camping on a cell of the PLMN or the SNPN and doing any necessary LRs.
qqqqq. UPLMN: PLMN/access technology combination in the “User Controlled PLMN Selector with Access Technology” data file in the SIM (in priority order).
rrrrr. OPLMN: PLMN/access technology combination in the “Operator Controlled PLMN Selector with Access Technology” data file in the SIM (in priority order) or stored in the ME (in priority order).
sssss. Acceptable Cell/Network: Acceptable cell/Network is the cell/Network that is not enough to be a suitable cell/Network, but meets the minimum condition at least to make an emergency call. The minimum conditions are:
   a. The cell/Network is not barred
   b. The cell/Network selection criteria is met
ttttt. Suitable Cell/Network: The cell that the UE may camp on for a normal service. The E-UTRA and UTRA Suitable Cell criteria is defined in 36.304 4.3 Service types in Idle Mode as follows.

The cell is part of either:
the selected PLMN (PLMN that has been selected by the NAS, either manually or automatically), or:
the registered PLMN (PLMN on which certain Location Registration outcomes have occurred.
a PLMN of the Equivalent PLMN list according to the latest information provided by NAS:
The cell is not barred;
The cell is part of at least one TA that is not part of the list of “forbidden tracking areas for roaming”
The cell selection criteria are fulfilled

S&F Satellite operation for delay-tolerant communication services: S&F Satellite operation is an operation mode of a 5G system with satellite-access, where the 5G system can provide some level of communication service (in storing and forwarding the data) when satellite connectivity is intermittently/temporarily unavailable, e.g. to provide communication service for UEs under satellite coverage without a simultaneous active feeder link connection to the ground segment. This is particularly relevant for delay-tolerant communication service.

The concept of “S&F” service is widely used in the fields of delay-tolerant networking and disruption-tolerant networking. In 3GPP context, a service that could be assimilated to an S&F service is SMS, for which there is no need to have an end-to-end connectivity between the end-points (e.g. an end-point can be a UE and the other an application server) but only between the end-points and the SMSC which acts as an intermediate node in charge of storing and relying.

The support of S&F Satellite operation is especially suited for the delivery of delay-tolerant/non-real-time satellite services with Non-Geostationary Satellite Orbits (NGSO) satellites.

satellite access: direct connectivity between the UE and the satellite.

serving satellite: a satellite providing the satellite access to a UE. In the case of NGSO (Non-Geostationary Satellite Orbit), the serving satellite is always changing due to the nature of the constellation.

S&F data retention period: it is the data storage validity period for the 5G system with satellite access supporting store and forward operation.

S&F Data Storage Quota: It is the maximum amount of Data Storage for the 5G system with satellite access supporting store and forward operation.

NAS messages as referred to herein can be (but not limited to) REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; SERVICE ACCEPT; UE CONFIGURATION UPDATE command, UE PARAMETERS UPDATE command, and so on.

The term 5GMM sublayer states in this embodiment are at least one of the below:
1) 5GMM-NULL
2) 5GMM-DEREGISTERED
   a) 5GMM-DEREGISTERED.NORMAL-SERVICE
   b) 5GMM-DEREGISTERED.LIMITED-SERVICE
   c) 5GMM-DEREGISTERED.ATTEMPTING-REGISTRATION
   d) 5GMM-DEREGISTERED.PLMN-SEARCH
   e) 5GMM-DEREGISTERED.NO-SUPI
   f) 5GMM-DEREGISTERED.NO-CELL-AVAILABLE
   g) 5GMM-DEREGISTERED.eCALL-INACTIVE
   h) 5GMM-DEREGISTERED.INITIAL-REGISTRATION-NEEDED
3) 5GMM-REGISTERED-INITIATED
4) 5GMM-REGISTERED
   a) 5GMM-REGISTERED.NORMAL-SERVICE
   b) 5GMM-REGISTERED.NON-ALLOWED-SERVICE
   c) 5GMM-REGISTERED.ATTEMPTING-REGISTRATION-UPDATE
   d) 5GMM-REGISTERED.LIMITED-SERVICE
   e) 5GMM-REGISTERED.PLMN-SEARCH
   f) 5GMM-REGISTERED.NO-CELL-AVAILABLE
   g) 5GMM-REGISTERED.UPDATE-NEEDED
5) 5GMM-DEREGISTERED-INITIATED
6) 5GMM-SERVICE-REQUEST-INITIATED

In this embodiment, the term EMM sublayer states are at least one of the below:

1) EMM-NULL
2) EMM-DEREGISTERED
   a) EMM-DEREGISTERED.NORMAL-SERVICE
   b) EMM-DEREGISTERED.LIMITED-SERVICE
   c) EMM-DEREGISTERED.ATTEMPTING-TO-ATTACH
   d) EMM-DEREGISTERED.PLMN-SEARCH
   e) EMM-DEREGISTERED.NO-IMSI
   f) EMM-DEREGISTERED.ATTACH-NEEDED
   g) EMM-DEREGISTERED.NO-CELL-AVAILABLE
   h) EMM-DEREGISTERED.eCALL-INACTIVE
3) EMM-REGISTERED-INITIATED
4) EMM-REGISTERED
   a) EMM-REGISTERED.NORMAL-SERVICE
   b) EMM-REGISTERED.ATTEMPTING-TO-UPDATE
   c) EMM-REGISTERED.LIMITED-SERVICE
   d) EMM-REGISTERED.PLMN-SEARCH
   e) EMM-REGISTERED.UPDATE-NEEDED
   f) EMM-REGISTERED.NO-CELL-AVAILABLE
   g) EMM-REGISTERED.ATTEMPTING-TO-UPDATE-MM
   h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

The term RAT as defined herein can be one of the following: NG-RAN, 5G, 4G, 3G, 2G, EPS, 5GS, NR, NR in unlicensed bands, NR (LEO) satellite access, NR (MEO) satellite access, NR (GEO) satellite access, NR (OTHERSAT) satellite access, NR RedCap, E-UTRA, E-UTRA in unlicensed bands NB-IoT, WB-IoT, LTE-M, and so on.

Registration or 5GS registration may refer to any 5GS Registration type which can be initial registration, mobility registration, updating periodic registration, updating emergency registration, SNPN onboarding registration, disaster roaming initial registration/disaster roaming mobility registration updating, and so on

PLMN selection as per 3GPP TS 23.122 without RPLMN: The MS selects and attempts registration on any PLMN/access technology combinations, if available and allowable, in the following order:
a) either the HPLMN (if the EHPLMN list is not present or is empty) or the highest priority EHPLMN that is available (if the EHPLMN list is present);
b) each PLMN/access technology combination in the “User Controlled PLMN Selector with Access Technology” data file in the SIM (in priority order);
c) each PLMN/access technology combination in the “Operator Controlled PLMN Selector with Access Technology” data file in the SIM (in priority order) or stored in the ME (in priority order);
d) other PLMN/access technology combinations with received high quality signal in random order; and
e) other PLMN/access technology combinations in order of decreasing signal quality.

PLMN selection as per 3GPP TS 23.122 with RPLMN: The MS selects and attempts registration on any PLMN/access technology combinations, if available and allowable, in the following order:
a) either the RPLMN or the Last registered PLMN;
b) either the HPLMN (if the EHPLMN list is not present or is empty) or the highest priority EHPLMN that is available (if the EHPLMN list is present);
c) each PLMN/access technology combination in the “User Controlled PLMN Selector with Access Technology” data file in the SIM (in priority order);
d) each PLMN/access technology combination in the “Operator Controlled PLMN Selector with Access Technology” data file in the SIM (in priority order) or stored in the ME (in priority order);
e) other PLMN/access technology combinations with received high quality signal in random order; and
f) other PLMN/access technology combinations in order of decreasing signal quality.

The terms, UE and MS, are used interchangeably in this embodiment and may have the same meaning.

The term area/location/geographical area are used in this embodiment may refer to any of cell/cell ID, TAC/TAI, PLMN, MCC/MNC, Latitude/longitude, CAG cell or any geographical location/coordinate.

The solutions explained in this embodiment are applicable to any (but not limited to) of the RAT(s) as defined in this embodiment. The Network or Network Functions used in this embodiment could be any 5G/E-UTRAN Core Network Entities like AMF/SMF/MME/UPF/PCF/AF/OAM/NEF/UDM/HSS or the Network could be any (but not limited to) 5G/E-UTRAN RAN Entity like eNodeB (eNB) or gNodeB (gNB) or NG-RAN etc.

The terms, unavailability period duration, unavailability period, discontinuous coverage, discontinuous coverage period and unavailability duration, are interchangeably used and may have the same meaning.

The terms, start time, start of unavailability period, start of unavailability duration, start of discontinuous coverage, start of discontinuous coverage period and start of unavailability period duration, are interchangeably used and may have the same meaning.

The terms, support of/for “Unavailability Period” and “Unavailability Period Support”, are used interchangeably and may have the same meaning.

The NTN and TN could either operate in two different frequency bands (e.g. FR1 vs FR2), or in same frequency band (e.g. FR1 or FR2).

The terms, NTN, 3GPP based Satellite Network, Satellite 3GPP access, Satellite access, Satellite Access Network, NR Satellite Access Network, Satellite NG-RAN Access Technology and NR Satellite access, have been interchangeably used and may have the same meaning.

The methods, issues, or solutions disclosed in this embodiment are explained using NR satellite access or Satellite NG-RAN Access Technology as an example and is not restricted or limited to NR Satellite access only. However, the solutions proposed in this embodiment are also applicable for any NTN Technology, any 3GPP based Satellite Network, any legacy 3GPP Networks (for example, NR, LTE), Satellite E-UTRAN access Technology, NB (Narrow Band)-S1 mode or WB (Wide Band)-S1 mode via satellite E-UTRAN access and/or NB-IOT (NarrowBand Internet Of Things) or WB-IOT (WideBand Internet Of Things) Satellite Access/Architecture.

The solutions and procedures which are defined for NR (5GC) are also applicable to legacy RATs like E-UTRA/LTE, the corresponding 5G CN entities needs to be replaced by LTE entities for example, AMF with MME, g-NodeB with e-NodeB, UDM with HSS etc. Similarly, the corresponding 5G procedures needs to be replaced by LTE procedures for example, Registration procedure with Attach Procedure, Registration procedure for mobility registration updating with TAU procedure, Deregistration Procedure with Detach procedure and so on. But principles of the solution remains same.

An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The Network used in this embodiment is explained using any 5G Core Network Function for example, AMF. However, the network could be any 5G/E-UTRAN Core Network Entities like AMF/SMF/MME/UPF or the Network could be any 5G/E-UTRAN RAN Entity like eNodeB (eNB) or gNodeB (gNB) or NG-RAN etc.

The messages used or indicated in this embodiment are shown as an example. The messages could be any signaling messages between UE and the Network Functions/Entities or between different Network functions/entities.

The term area/location/geographical area are used in this embodiment may refer to any of cell/cell ID, TAC/TAI, PLMN, MCC/MNC, Latitude/longitude, CAG cell or any geographical location/coordinate.

The 3GPP Technical document and references and the version number given in this embodiment are for reference/example and may be present in or refer to any of the 3GPP Technical documents or references.

In this embodiment, SIB19, SIB32 are given for examples and the parameters/indication from Network can be configured in any of the broadcast or signaling messages.

The methods, issues or solutions disclosed in this embodiment are explained using NR access or NG-RAN Access Technology as an example and is not restricted or limited to NR access only. However, the solutions proposed in this embodiment are also applicable for E-UTRAN access Technology, NB (Narrow Band)-S1 mode or WB (Wide Band)-S1 mode via E-UTRAN access and/or NB-IoT (NarrowBand Internet Of Things) or WB-IoT (WideBand Internet Of Things) Access/Architecture.

The solutions which are defined for NR (5GC) are also applicable to legacy RATs like E-UTRA/LTE, the corresponding CN entities needs to be replaced by LTE entities for example, AMF with MME, g-NodeB with e-NodeB, UDM with HSS etc. But principles of the solution remains same.

The Network used in this embodiment is explained using any 5G Core Network Function for example, AMF. However, the network could be any 5G/E-UTRAN Core Network Entities like AMF/SMF/MME/UPF or the Network could be any 5G/E-UTRAN RAN Entity like eNodeB (eNB) or gNodeB (gNB) or NG-RAN etc.

The messages used or indicated in this embodiment are shown as an example. The messages could be any signaling messages between UE and the Network Functions/Entities or between different Network functions/entities.

The terms, camp and register, are used interchangeably and may have the same meaning.

The solutions and procedures defined in this embodiment are illustrated using 5G or LTE as an example. It could be any applicable for any RAT(s)/Access but the core principles remains the same.

The terms, camp, register, attach and Tracking area update (TAU), are interchangeably used in this embodiment and may have the same meaning.

The solutions and procedures defined in this embodiment are illustrated using one of cell(s), RAT(s), PLMN(s) and Access(es) as an example. It could be applicable for any Network or Network Entity and the core principle remains the same.

The term area as used in this embodiment may refer to any of cell/cell ID, TAC/TAI, PLMN, MCC/MNC, Latitude/longitude, any CAG/CAG identifier or any geographical location/coordinate.

For the list of possible NAS messages please refer to 3GPP TS 24.501 or 3GPP TS 24.301, for list of AS messages please refer to 3GPP TS 38.331 or 3GPP TS 36.331

The cause names in this embodiment are for illustration purpose and it can have any name. The Non Access Stratum (NAS) messages and Access Stratum (AS) messages described in this embodiment is only for illustration purpose it can be any NAS or AS messages as per defined protocol between UE and AMF/MME or UE and gNB (NG-RAN/any RAN node)/eNB.

The term Network as used in this embodiment may refer to any PLMN, RAT, Access, Access Technology or any combination of these.

The term NTN or NR/E-UTRAN Satellite Access Network as used in this embodiment may refer to any of the NR Satellite Access Network or E-UTRAN Satellite Access Network or NR Satellite Access Technology or E-UTRAN Satellite Access Technology.

In this embodiment, RPLMN and LRPLMN may refer to the same thing and have same meaning.

In this embodiment, Registered PLMN and Last Registered PLMN may refer to the same thing and have same meaning.

The terms searching, scanning, selecting, registering, attaching, initiating Tracking Area Update (TAU) and camping have been used interchangeable and have same meaning.

The terms, unavailability period duration, unavailability period, discontinuous coverage, discontinuous coverage period and unavailability duration, are interchangeably used and may have the same meaning.

The terms, start time, start of unavailability period, start of unavailability duration, start of discontinuous coverage, start of discontinuous coverage period and start of unavailability period duration, are interchangeably used and may have the same meaning.

In Non-Terrestrial Networks (NTN), Continuous satellite coverage can be characterized by the fact that ‘Uu interface’ is available for the UE, at a given position for 100% of the time.

The terms, unavailability period duration, unavailability period, discontinuous coverage, discontinuous coverage period and unavailability duration, are interchangeably used and may have the same meaning.

The terms, start time, start of unavailability period, start of unavailability duration, start of discontinuous coverage, start of discontinuous coverage period and start of unavailability period duration, are interchangeably used and may have the same meaning.

In Non-Terrestrial Networks (NTN), Continuous satellite coverage can be characterized by the fact that Uu interface is available for the UE, at a given position for 100% of the time.

In Non-Terrestrial Networks (NTN), Discontinuous satellite coverage can be characterized by the fact that Uu interface is available for the UE, at a given position, less than 100% of the time, due to predictable lack of satellite coverage.

Due to Discontinuous coverage, the UE may have access to satellite service coverage only at specific time and places.

In Non-Terrestrial Networks (NTN), Discontinuous satellite coverage can be characterized by the fact that Uu interface is available for the UE, at a given position, less than 100% of the time, due to predictable lack of satellite coverage.

Due to Discontinuous coverage, the UE may have access to satellite service coverage only at specific time and places.

As used herein, the term “network” may refer to one or more of a Public Land Mobile Network (PLMN) or a Radio Access Technology (RAT) or an access or a system or a Radio Access Network (RAN) or a band or a frequency or a cell or a Network entity or a Network function or any Terrestrial Network or any Non-Terrestrial Network or any component of the network.

As used herein, the term “Non-Terrestrial Network (NTN)” may refer to one or more of a non-terrestrial PLMN or a non-terrestrial RAT or a non-terrestrial access or a non-terrestrial system or a non-terrestrial RAN or a non-terrestrial band or a non-terrestrial frequency or a non-terrestrial cell or a non-terrestrial Network entity or a non-terrestrial network function or a component of a non-terrestrial network or a network other than TN or a network on Satellite Access Network.

As used herein, the term “Terrestrial Network (TN)” may refer to one or more of a terrestrial PLMN or a terrestrial RAT or a terrestrial access or a terrestrial system or a terrestrial RAN or a terrestrial band or a terrestrial frequency or a terrestrial cell or a terrestrial Network entity or a terrestrial network function or a component of a terrestrial network or a Network other than NTN or a network other than Satellite Access Network.

As used herein, the term “User Equipment (UE)” may refer to one or more of an NTN-capable UE or a UE capable of availing a NTN service or a UE supporting NTN technology or a UE capable of getting NTN services using technologies other than NTN technology or a UE capable of availing a NTN service which is deployed using a 3rd Generation Partnership Project (3GPP) Satellite or NTN system or a UE capable of availing a NTN service which is deployed using a NTN Network deployed using any 3GPP technology or a UE capable of availing a NTN service which is deployed using any proprietary NTN implementation outside the scope of 3GPP NTN system or a UE having a usage setting as a voice centric UE or a UE configured to send or to receive Attach Type as Combined International Mobile Subscriber Identity (IMSI) or a UE configured to send or to receive Attach Type as Combined IMSI with SMS only.

As used herein, the term “registration procedure” is associated with registration or camping of a UE in a 5G network.

As used herein, the term “attach procedure” is associated with registration or camping of a UE in a 4G network or Long-Term Evolution (LTE) network.

As used herein, the term “detach” is associated with de-registration or detaching of a UE in a 4G Network or a LTE network.

As used herein, the term “deregistration” is associated with de-registration or detaching of a UE in a 5G Network or a NR network.

As used herein, a “voice-centric user Equipment (UE)” may refer to a UE with support for voice services for example, IP Multimedia System (IMS) voice or any other voice services.

As used herein, “camping” or “registering” to a network or network cell refers to the process by which a UE (for example, a mobile phone or tablet or the like) connects to a specific cellular network and becomes associated with that network. It may also refer to a procedure where the UE has completed the cell/Network selection/reselection process and has chosen a cell/Network from which it plans to receive all available services. It may also refer to a process of selecting a cell of the PLMN/Network and doing any necessary procedures (for example, Location Registration) to avail services from the Network.

As used herein, a “non-availability of a Terrestrial Network (TN) coverage at the location of the UE” may refer to a situation where there may be no terrestrial network available at the location of the UE or there may be terrestrial network(s) available in the location of the UE but those Terrestrial Network may not be suitable or allowable for the UE for getting normal services (for example, UE may not be able to get normal services (for example, full set of services such as Voice, Data, SMS, etc.) from those terrestrial network. Those terrestrial network may be a part of a forbidden list present in the UE). The UE may assume that the UE is in a location where Terrestrial Network coverage is not available

As used herein, a “presence of the UE in an NTN only coverage area” may refer to a situation where there may be only non-terrestrial network available at the location of the UE or there may be NTN available at the location of the UE and there may be terrestrial network(s) available in the location of the UE but those Terrestrial Network may not be suitable or allowable for the UE for getting normal services (for example, UE may not be able to get normal services (for example, full set of services such as Voice, Data, SMS, etc.) from those terrestrial network.

As used herein, an “allowable network” for the UE may be those Network(s) which are not a part of any of the back-off network list or a forbidden network list or a temporary back-off/forbidden Network list of the UE. It may refer to a network on which UE is allowed to camp or register to get normal or full services.

As used herein, Packet Switching (PS) mode and Circuit Switching (CS) mode are the two different types of traffic modes that devices (or UEs) can use to access the network.

As used herein, the N1 mode refers to the standalone mode with a direct connection between the 5G Radio Access Network (RAN) and 5G Core Network (CN). In the N1 mode, the NG interface is used between RAN and 5GCN.

As used herein, the S1 mode is associated with the Evolved Packet System (EPS) and uses the 4G core network. In S1 mode, the 4G S1 interface is used between RAN and EPC.

As used herein, a “temporary forbidden PLMN list” refers to a list of Public Land Mobile Networks (PLMNs) stored at the UE. The list indicates the PLMNs the UE is temporarily configured to avoid camping or registering. The list indicates the list of PLMN(s) which are not a part of allowable PLMN(s) of the UE. The UE may not allowed to register or attach to the list of the PLMN(s) which are a part of “temporary forbidden PLMN list” for normal services.

As used herein, the back-off timer in the 3GPP standard is a mechanism used to control the frequency of retransmissions in a wireless communication system. The back-off timer is mainly utilized to alleviate the overload of the Mobility Management Entity (MME) or AMF or a RAN entity (for example, g-NodeB or NG-RAN or eNodeB, etc.) and to resolve congestion at the Serving Gateway (S-GW), or the SMF or the UPF or the Packet Data Gateway (P-GW).

As used herein, the Non-3GPP Inter-Working Function (N3IWF) interface in the 5G SBA (Service Based Architecture) is responsible for interworking between untrusted non-3GPP networks and the 5G core. N3IWF facilitates seamless handover and uninterrupted connectivity for users when they transition between different network types.

As used herein, the Evolved Packet Data Gateway (ePDG) is responsible for interworking between the Evolved Packet Core (EPC) and untrusted non-3GPP networks that require secure access, such as Wi-Fi, Long-Term Evolution (LTE) metro, and femtocell access networks.

The UE may determine that the UE is in NR/Evolved Universal Terrestrial Radio Access Network (E-UTRAN) Satellite Access Discontinuous Coverage, optionally for a selected PLMN or network, through at least one of the below methods: a) Based on the start of the unavailability period and/or unavailability period duration determined by the UE, indicated by the network (i.e., by any network function such as AMF, Mobility Management Entity (MME) etc.) or negotiated between the UE and the network. For example—if the current time is after the start time and the unavailability period duration is not over, the UE may determine that the UE is in discontinuous coverage, optionally for the selected PLMN or network; b) Based on the unavailability type, which indicates that the unavailability period is due to NR/E-UTRAN Satellite Access Network discontinuous coverage; c) Based on any of the network broadcast parameters or messages or any network indication (such as SIB-19, SIB-32); d) Based on UE determination. e) Based on Satellite Coverage Availability Information (SCAI) provided to the UE by (Application Function) AF or the 5GC (Network Function) NF (like AMF/Policy Control Function (PCF)/Unified Data Management (UDM) or any other NF etc.) or any other entity such as SCAF (Satellite Coverage Availability Function). f) Based on any other methods or indication.

In an embodiment, the UE determines that the UE is in the discontinuous coverage of the network by using at least one of: a broadcast parameter; a SIB parameter; a NAS signaling parameter; an AS signaling parameter; an information regarding configuration for NTN deployment as configured in the UE; an information regarding configuration for the NTN deployment as indicated by the network; an unavailability period duration and a start of unavailability period; an unavailability type; an indication for store and forward mode; a satellite coverage availability information (SCAI); a satellite ephemeris information; an information regarding configuration for the NTN deployment as configured in a SIM; an information regarding configuration for the NTN deployment as indicated by a server; an information regarding configuration for the NTN deployment as indicated by an application function; a database indicating details of a satellite or NTN cell, its location, its availability/unavailability time and its deployment details; a machine learning or an artificial intelligence based technique to predict or determine a network availability and unavailability status; and a data driven technique to predict or determine a Network availability and unavailability status.

The method as described in this embodiment, includes prior to transmitting the registration request or Attach Request or TAU request or any AS/NAS signaling message comprises: receiving, by the UE, a satellite coverage availability information from an application function or from the Network; and determining, by the UE, a value of the unavailability period duration and a value of the start of unavailability period based on the received satellite coverage availability information.

The method as described in this embodiment, includes receiving, by the network apparatus, unavailability information due to discontinuous coverage, when the UE initiates an AS/NAS signaling procedure.

In this embodiment, the unavailability information is at least one of: a start of unavailability period, an unavailability period duration and an unavailability type.

The method, as described in this embodiment, the unavailability type is set to unavailability due to the discontinuous coverage.

In an embodiment, the method, as described in this embodiment, the unavailability type may be set to any value (for example, unavailability due to the discontinuous coverage or unavailability due to UE reasons).

The method, as described in this embodiment, the unavailability information is sent in at least one of: a registration request procedure, a mobility registration update procedure, an attach procedure, a tracking area update and a service request procedure.

Discontinuous coverage indicates a duration of no service to the UEs followed by duration of service availability for the UEs. For example, UE may be in satellite coverage between 10 to 1, later at 1 UE may get into discontinuous coverage i.e. NO service. Again after certain hours e.g. 3 hours UE may get the service back on satellite access. This because the satellite which was serving in the area may travel to next location and current location is not served by another satellite.

In Non-Terrestrial Networks (NTN), Continuous satellite coverage can be characterized by the fact that Uu interface is available for the UE, at a given position for 100% of the time.

In Non-Terrestrial Networks (NTN), Discontinuous satellite coverage can be characterized by the fact that Uu interface is available for the UE, at a given position, less than 100% of the time, due to predictable lack of satellite coverage.

Due to Discontinuous coverage, the UE may have access to satellite service coverage only at specific time and places.

In Non-Terrestrial Networks (NTN), Discontinuous satellite coverage can be characterized by the fact that Uu interface is available for the UE, at a given position, less than 100% of the time, due to predictable lack of satellite coverage.

NTN may correspond to an NTN system or several NTN cells. In an embodiment, wherein the NTN includes at least one of: Low Earth Orbit (LEO), Medium Earth Orbit (MEO), Geostationary Orbit (GEO), High Altitude Platform Systems (HAPS), Unmanned Aerial Vehicle (UAV), Unmanned Aircraft System (UAS), a network supported by an airborne vehicle, a Network deployed using the 3rd Generation Partnership Project (3GPP) Satellite or NTN system, a NTN Network deployed using at least one 3GPP technology (for example, a 3GPP based Satellite system or a NTN Network deployed using a LTE network, etc.) and a NTN Network deployed using at least one NTN implementation outside the scope of 3GPP NTN system (for example, a NTN deployed using an operator server or application, etc.) (for example, a NTN deployed using an operator server or application, etc.). (for example, in some cases, the network operators or the satellite vendors are deploying NTN services using existing 3GPP Technologies (for example, using 3GPP RAT(s) such as LTE, i.e. deploying LTE-based Satellite system) to ease the deployment).

Moreover, the network operators, in some cases, are deploying NTN services using existing 3GPP Technologies (for example, using 3GPP RAT(s) such as LTE, i.e. deploying LTE-based Satellite system) to ease the deployment.

The terms, NTN, 3GPP based Satellite Network, Satellite 3GPP access, Satellite access, Satellite Access Network, NR Satellite Access Network, Satellite NG-RAN Access Technology, NR Satellite access, LTE Satellite Access Network, Satellite E-UTRAN Access Technology, and LTE Satellite access, have been interchangeably used and may have the same meaning.

In an embodiment, the UE ignores the last registered network or the UE ignores the NTN or the UE ignores the last registered PLMN during a network search procedure. In an embodiment, the UE ignores the last registered network or the UE ignores the NTN or the UE ignores the last registered PLMN if the selected network is same as the last registered network/PLMN and the last registered network/PLMN is a NTN. In an embodiment, the UE ignores the NTN if the selected network is a NTN during network search procedure.

The solutions stated in this embodiment are illustrated using RPLMN or the last registered Network. However, the same solutions are also applicable to RPLMN and/or its equivalent PLMN, Last registered Network or its equivalent Network, RPLMN and/or its equivalent PLMN over NTN or over Satellite access technology, RPLMN and/or its equivalent PLMN over any access technologies, RPLMN over NTN or over Satellite access technology, RPLMN over any access technologies, Last Registered Network over any access technologies, Last Registered Network over NTN or over Satellite access technology and the core principle remains the same.

There may be one or more terrestrial networks available in those area, but those terrestrial networks may not be suitable or allowable for the UE for getting normal services (for example, UE may not be able to get normal services (for example, full set of services such as Voice, Data, SMS, etc.) from those terrestrial network (for example, those terrestrial network may not have any partnership with the Network Operator or Home PLMN (HPLMN) of the UE and may not provide normal services to the UE). Those terrestrial network may be a part of a forbidden list present in the UE). The UE may assume that the UE is in a location where Terrestrial Network coverage is not available and only NTN coverage may be available in the location which may provide normal service to the UE (for example, normal service with only SMS or Data, etc.). The NTN may be deployed by the HPLMN or any of the partner network of the Network Operator/HPLMN of the UE.

As used herein, a “non-availability of a Terrestrial Network (TN) coverage at the location of the UE” may refer to a situation where there may be no terrestrial network available at the location of the UE or there may be terrestrial network(s) available in the location of the UE but those Terrestrial Network may not be suitable or allowable for the UE for getting normal services (for example, UE may not be able to get normal services (for example, full set of services such as Voice, Data, SMS, etc.) from those terrestrial network. Those terrestrial network may be a part of a forbidden list present in the UE). The UE may assume that the UE is in a location where Terrestrial Network coverage is not available

As used herein, a “presence of the UE in an NTN only coverage area” may refer to a situation where there may be only non-terrestrial network available at the location of the UE or there may be NTN available at the location of the UE and there may be terrestrial network(s) available in the location of the UE but those Terrestrial Network may not be suitable or allowable for the UE for getting normal services (for example, UE may not be able to get normal services (for example, full set of services such as Voice, Data, SMS, etc.) from those terrestrial network.

As used herein, an “allowable network” for the UE may be those Network(s) which are not a part of any of the back-off network list or a forbidden network list or a temporary back-off/forbidden Network list of the UE. It may refer to a network on which UE is allowed to camp or register to get normal or full services.

NTN may correspond to an NTN system or several NTN cells. In an embodiment, wherein the NTN includes at least one of: Low Earth Orbit (LEO), Medium Earth Orbit (MEO), Geostationary Orbit (GEO), High Altitude Platform Systems (HAPS), Unmanned Aerial Vehicle (UAV), Unmanned Aircraft System (UAS), a network supported by an airborne vehicle, a Network deployed using the 3rd Generation Partnership Project (3GPP) Satellite or NTN system, a NTN Network deployed using at least one 3GPP technology (for example, a 3GPP based Satellite system or a NTN Network deployed using a LTE network, etc.) and a NTN Network deployed using at least one NTN implementation outside the scope of 3GPP NTN system (for example, a NTN deployed using an operator server or application, etc.) (for example, a NTN deployed using an operator server or application, etc.). (for example, in some cases, the network operators or the satellite vendors are deploying NTN services using existing 3GPP Technologies (for example, using 3GPP RAT(s) such as LTE, i.e. deploying LTE-based Satellite system) to ease the deployment . . . ).

Moreover, the network operators, in some cases, are deploying NTN services using existing 3GPP Technologies (for example, using 3GPP RAT(s) such as LTE, i.e. deploying LTE-based Satellite system) to ease the deployment.

The terms, NTN, 3GPP based Satellite Network, Satellite 3GPP access, Satellite access, Satellite Access Network, NR Satellite Access Network, Satellite NG-RAN Access Technology, NR Satellite access, LTE Satellite Access Network, Satellite E-UTRAN Access Technology, and LTE Satellite access, have been interchangeably used and may have the same meaning.

In an embodiment, the UE ignores the last registered network or the UE ignores the NTN or the UE ignores the last registered PLMN during a network search procedure. In an embodiment, the UE ignores the last registered network or the UE ignores the NTN or the UE ignores the last registered PLMN if the selected network is same as the last registered network/PLMN and the last registered network/PLMN is a NTN. In an embodiment, the UE ignores the NTN if the selected network is a NTN during network search procedure.

The solutions stated in this embodiment are illustrated using RPLMN or the last registered Network. However, the same solutions are also applicable to RPLMN and/or its equivalent PLMN, Last registered Network or its equivalent Network, RPLMN and/or its equivalent PLMN over NTN or over Satellite access technology, RPLMN and/or its equivalent PLMN over any access technologies, RPLMN over NTN or over Satellite access technology, RPLMN over any access technologies, Last Registered Network over any access technologies, Last Registered Network over NTN or over Satellite access technology and the core principle remains the same.

There may be one or more terrestrial networks available in those area, but those terrestrial networks may not be suitable or allowable for the UE for getting normal services (for example, UE may not be able to get normal services (for example, full set of services such as Voice, Data, SMS, etc.) from those terrestrial network (for example, those terrestrial network may not have any partnership with the Network Operator or Home PLMN (HPLMN) of the UE and may not provide normal services to the UE). Those terrestrial network may be a part of a forbidden list present in the UE). The UE may assume that the UE is in a location where Terrestrial Network coverage is not available and only NTN coverage may be available in the location which may provide normal service to the UE (for example, normal service with only SMS or Data, etc.). The NTN may be deployed by the HPLMN or any of the partner network of the Network Operator/HPLMN of the UE.

As used herein, a “non-availability of a Terrestrial Network (TN) coverage at the location of the UE” may refer to a situation where there may be no terrestrial network available at the location of the UE or there may be terrestrial network(s) available in the location of the UE but those Terrestrial Network may not be suitable or allowable for the UE for getting normal services (for example, UE may not be able to get normal services (for example, full set of services such as Voice, Data, SMS, etc.) from those terrestrial network. Those terrestrial network may be a part of a forbidden list present in the UE). The UE may assume that the UE is in a location where Terrestrial Network coverage is not available

As used herein, a “presence of the UE in an NTN only coverage area” may refer to a situation where there may be only non-terrestrial network available at the location of the UE or there may be NTN available at the location of the UE and there may be terrestrial network(s) available in the location of the UE but those Terrestrial Network may not be suitable or allowable for the UE for getting normal services (for example, UE may not be able to get normal services (for example, full set of services such as Voice, Data, SMS, etc.) from those terrestrial network.

As used herein, an “allowable network” for the UE may be those Network(s) which are not a part of any of the back-off network list or a forbidden network list or a temporary back-off/forbidden Network list of the UE. It may refer to a network on which UE is allowed to camp or register to get normal or full services.

In an embodiment, the UE may identify the availability of an NTN using any of parameters or procedures in any order or combination: identify a Network deployed by the network operator using one or more of the NTN technology, identify one or more parameters associated with deploying the NTN technology, identify one or more information associated with deploying the NTN technology, perform the identification based on an agreement between a network operator, an NTN vendor, and the UE, determine the information of the Network (for example, Cell/Band/Frequency/RAT/PLMN/Access, etc.) on which the NTN is deployed using an indication from the Network or an indication from any of the servers or an information configured or pre-configured in the UE, identify the deployment of the NTN technology on the basis of identification or determination or reception of one or more parameters by the UE 100. The one or more parameters may include a broadcast parameter, a System Information Block (SIB) parameter, a Non-access stratum (NAS) signaling parameter, and an access stratum (AS) signaling parameters.

In an embodiment, the UE may identify the availability of an NTN based on the network parameters and network conditions, for example, a band used by an operator or a satellite vendor for deploying a satellite service or an NTN service; a PLMN used by an operator or a satellite vendor for deploying a satellite service or an NTN service; a frequency used by an operator or a satellite vendor for deploying a satellite service or an NTN service; a RAT used by an operator or a satellite vendor for deploying a satellite service or an NTN service; a network deployed using any of an NTN technology; and a network used by a satellite vendor for deploying a satellite service or an NTN service.

In an embodiment, the UE may identify the availability of an NTN on the basis of identification or reception of one or more information associated with deploying the NTN technology. The one or more information may include: an information regarding configuration for NTN deployment in the UE; an information regarding configuration for NTN deployment as indicated by the network; an information regarding configuration for NTN deployment as configured in a Subscriber Identity Module (SIM); an information regarding configuration for NTN deployment as indicated by a server; an information regarding configuration for NTN deployment as indicated by an application function; an information from a database where the database contains information indicating details of a satellite or NTN cell, its location, its availability/unavailability time and its deployment details; an information generated by a machine learning or an artificial intelligence model to predict or determine a network type; an information acquired using a data driven technique to predict or determine a network type.

In an embodiment, the UE registered to the network is at least one of: the UE is registered to the TN; the UE is registered to the NTN; a UE is registered to a 3GPP network; and a UE is registered to a Non-3GPP (N3GPP) network.

The list of satellite IDs, allowable list of satellite IDs, allowable Satellite IDs or list of allowable Satellite IDs are used interchangeably and may have the same meaning.

The term NTN or NR/E-UTRAN Satellite Access Network as used in this embodiment may refer to any of the NR Satellite Access Network or E-UTRAN Satellite Access Network or NR Satellite Access Technology or E-UTRAN Satellite Access Technology.

In this embodiment, the term Satellite is used interchangeably with 5G or 4G system with satellite access and is used to represent any satellite(s) or constellation of Satellites(s) or any aerial body/satellite in any of the satellite orbits (for ex-LEO/MEO/GEO/HEO, etc.) or any 5G system with Satellite Access or 4G System with Satellite Access or any RAN Entity or Core Network Entity or any Network Function(s) associated with the Satellite Access/RAT/PLMN/Network.

The terms, unavailability period duration, unavailability period, discontinuous coverage, discontinuous coverage period and unavailability duration, are interchangeably used and may have the same meaning.

The terms, start time, start of unavailability period, start of unavailability duration, start of discontinuous coverage, start of discontinuous coverage period and start of unavailability period duration, are interchangeably used and may have the same meaning.

The terms, support of/for “Unavailability Period” and “Unavailability Period Support”, are used interchangeably.

The terms, NTN, 3GPP based Satellite Network, Satellite 3GPP access, Satellite access, Satellite Access Network, NR Satellite Access Network, Satellite NG-RAN Access Technology and NR Satellite access, have been interchangeably used and may have the same meaning.

In this embodiment, SIB19, SIB32 are given for examples and the parameters/indication from Network can be configured in any of the broadcast or signaling messages.

The terms, select, camp, register, attach and Tracking area update (TAU), are interchangeably used in this embodiment and may have the same meaning.

The terms, UE, ME and MS, are used interchangeably in this embodiment and may have the same meaning.

The terms, select, search and scan, are used interchangeably in this embodiment and may have the same meaning.

The solutions stated in this embodiment are illustrated using RPLMN or the last registered Network. However, the same solutions are also applicable to RPLMN and/or its equivalent PLMN, Last registered Network or its equivalent Network, RPLMN and/or its equivalent PLMN over any access technologies, RPLMN over any access technologies, Last Registered Network over any access technologies and the core principle remains the same.

In an embodiment, the UE may add the last selected or the registered Network (for example, PLMN or RAT or Cell or Band or Network any combination of these) to any temporary back-off Network List or forbidden Network List or any back-off list. The UE may not select or search or scan or deprioritize or ignore or scan with lowest priority the Network (for example, cell/PLMN/RAT/Access/Band/Network) present in this list.

In embodiments herein, after the network search procedure, the UE may camp or attach or register on any of the selected available Network. The UE may prefer to camp or attach or register or trigger a TAU on TN before triggering a search or scanning for the NTN and optionally, camping or attaching or registering or triggering a TAU on TN

In embodiments herein, the solutions are explained by applying during Network Search procedure. However, the solutions are also applicable before or during or after the Network search procedure and the core principle remains the same.

In an embodiment, the UE performs the network search procedure, when the UE detects an event.

In an embodiment, the UE performs the network search procedure and selects the TN on at least one of: a terrestrial PLMN; a terrestrial RAT; a terrestrial access; a terrestrial system; a terrestrial RAN; a terrestrial band; a terrestrial frequency; a terrestrial cell; a terrestrial CN entity; a terrestrial network entity, a component of terrestrial network, a terrestrial network function, a network other than NTN; and a network other than satellite access network.

In embodiments herein, the terms, event, trigger event and trigger conditions, are used interchangeably in this embodiment and may have the same meaning.

In an embodiment, the UE ignores the NTN on at least one of: a non-terrestrial PLMN; a non-terrestrial RAT; a non-terrestrial access; a non-terrestrial system; a non-terrestrial RAN; a non-terrestrial band; a non-terrestrial frequency; a non-terrestrial cell; a non-terrestrial CN entity; a non-terrestrial network function, a non-terrestrial CN entity, a component of a non-terrestrial network a network other than TN; and a network on satellite access network.

In embodiments herein, the solutions are explained using Higher Priority PLMN Search timer expiry as an example. However the solutions are applicable to any trigger conditions, for example, at least one of: an expiry of a timer for higher priority PLMN search procedure, a handover procedure, a redirection procedure, a reselection procedure, an expiry of a timer for Better System Reselection (BSR), an expiry of an operator defined timer, a background network search procedure, an idle mode procedure, a connected mode procedure and a network release procedure. The events may also include scenarios where the UE need to trigger or perform a Network Search or selection or scanning procedure, a PLMN Search or selection or scanning procedure, a Cell search or selection or scanning procedure or a RAT/Access Search or selection or scanning procedure.

In an embodiment, the event or trigger event includes at least one of: a switch off the UE, a switch on the UE, a recovery of the UE from lack of a coverage area, a recovery of the UE from an OOS area, a SIM insertion in the UE, a SIM re-insertion post removal in the UE, a SIM removal in the UE, a disabling of the SIM in the UE, an enabling of the SIM in the UE, a modem reset, a power cycle, a modem power up, a modem power cycle, an airplane mode on in the UE, an airplane mode off in the UE, a UE exiting airplane mode, a UE entering airplane mode, a modem exiting airplane mode, an activation of the UE, a reject cause from the network, a detach triggered by the network, a deregistration triggered by the network, on entering store and forward mode in the UE, on exiting store and forward mode in the UE, on entering store and forward mode from the network, on exiting store and forward mode from the network, a detach triggered by the UE, a deregistration triggered by the UE, a network mode change in the UE, a network selection mode change in the UE, an operating mode change in the UE, on entering satellite mode in the UE, on exiting satellite mode in the UE, a turning on of a modem, and a SIM refresh procedure. These events may also be referred to as “trigger conditions” in this embodiment. The events may also include scenarios where the UE need to trigger or perform a Network Search or selection or scanning procedure, a PLMN Search or selection or scanning procedure, a Cell search or selection or scanning procedure or a RAT/Access Search or selection or scanning procedure.

Cell search is an initial action performed by the cellular device after it is powered on to find available base stations for getting service. Cell search is a basic procedure which all cellular devices need to perform.
Device needs to synchronize in time and frequency domain with the cell and decode the cell ID of the transmitting cell for the cell search to be termed successful.
During Cell search device scans a wide range of frequencies to find available cells. The range of frequencies scanned varies on the basis of number of bands supported by the device.
The device is tuned to a particular frequency and basic signal (such as RSSI) measurement is performed.
As scanning of Wide range of frequencies is involved, the cell search takes large time to complete and thus it is high power consuming process.
In dual SIM devices, the cell search procedure is performed for both the SIMs independently. As a result, the power consumption related to cell search is twice as much, as for both the SIMs, UE has to scan wide range of frequencies to find suitable cell.
With introduction of NTN in 3GPP release 18, the devices supporting NTN coverage may perform scan on NTN RATs, resulting in more power consumption in NTN bands scanning.
If in an area, like remote/unpopulated areas, the cellular coverage may not be available, in such a case the device constantly keeps on scanning all the bands in search of service.

As used herein, the term “registration procedure” is associated with registration or camping of a UE in a 5G network.

As used herein, the term “attach procedure” is associated with registration or camping of a UE in a 4G network or Long-Term Evolution (LTE) network.

As used herein, the term “detach” is associated with de-registration or detaching of a UE in a 4G Network or a LTE network.

As used herein, the term “deregistration” is associated with de-registration or detaching of a UE in a 5G Network or a NR network.

As used herein, “camping” or “registering” to a network or network cell refers to the process by which a UE (such as a mobile phone or a tablet) connects to a specific cellular network and becomes associated with that network. It may also refer to a procedure where the UE has completed the cell/Network selection/reselection process and has chosen a cell/Network from which it plans to receive all available services. It may also refer to a process of selecting a cell of the PLMN/Network and doing any necessary procedures (for example, Location Registration) to avail services from the Network.

The term “Network” as used in this embodiment may refer to any PLMN, RAT, Access, Access Technology, Cell, Satellite or any combination of these.

As used herein, the term “network” may refer to one or more of a Public Land Mobile Network (PLMN) or a Radio Access Technology (RAT) or an access or a system or a Radio Access Network (RAN) or a band or a frequency or a cell or a Network entity or a Core Network (CN) entity or a Network function or any Terrestrial Network or any Non-Terrestrial Network or any component of the network.

The solutions defined in this embodiment are defined using PLMN selection or Network search as an example but it can refer to any of the Network Selection or Search procedures (for example, Cell Selection/Search, RAT selection/search, PLMN Selection/Search, etc.)

The solutions and procedures defined in this embodiment are illustrated using 5G or LTE as an example. It could be any applicable for any RAT(s)/Access but the core principles remains the same.

The solutions and procedures defined in this embodiment are illustrated using one of cell(s), RAT(s), PLMN(s) and Access(es) as an example. It could be applicable for any Network or Network Entity and the core principle remains the same.

The methods, issues or solutions disclosed in this embodiment are explained using NR access or NG-RAN Access Technology as an example and is not restricted or limited to NR access only. However, the solutions proposed in this embodiment are also applicable for E-UTRAN access Technology, NB (Narrow Band)-S1 mode or WB (Wide Band)-S1 mode via E-UTRAN access and/or NB-IOT (NarrowBand Internet Of Things) or WB-IOT (WideBand Internet Of Things) Access/Architecture.

The solutions which are defined for NR (5GC) are also applicable to legacy RATs like E-UTRA/LTE, the corresponding CN entities needs to be replaced by LTE entities for example, AMF with MME, g-NodeB with e-NodeB, UDM with HSS etc. But principles of the solution remains same. In the similar way, the solutions or proposal which are defined for LTE (EPC) are also applicable to other RAT(s) (for ex-5G or 5GC and other RATs)

The Network used in this embodiment is explained using any 5G Core Network Function, for example, AMF. However, the network could be any 5G/E-UTRAN Core Network Entities like AMF/SMF/MME/UPF/UDM or the Network could be any 5G/E-UTRAN RAN Entity like eNodeB (eNB) or gNodeB (gNB) or NG-RAN etc.

The 3GPP Technical document and references and the version number given in this embodiment are for reference/example and may be present in or refer to any of the 3GPP Technical documents or references.

The messages used or indicated in this embodiment are shown as an example. The messages could be any signaling messages between UE and the Network Functions/Entities or between different Network functions/entities.

The Network used in this embodiment is explained using any 5G Core Network Function for example, AMF. However, the network could be any 5G/E-UTRAN Core Network Entities like AMF/SMF/MME/UPF/S-GW/P-GW/UDM/HSS or the Network could be any 5G/E-UTRAN RAN Entity like eNodeB (eNB) or gNodeB (gNB) or NG-RAN, etc.

The solutions and procedures which are defined for NR (5GC) are also applicable to legacy RATs like E-UTRA/LTE, the corresponding 5G CN entities needs to be replaced by LTE entities for example, AMF with MME, g-NodeB with e-NodeB, UDM with HSS etc. Similarly, the corresponding 5G procedures needs to be replaced by LTE procedures for example, Registration procedure with Attach Procedure, Registration procedure for mobility registration updating with TAU procedure, Deregistration Procedure with Detach procedure and so on. But principles of the solution remains same.

The solutions which are defined for LTE (EPC) are also applicable to other RATs like NR/NG-RAN/5GC, the corresponding CN entities needs to be replaced by NR entities for example, MME with AMF, e-NodeB with g-NodeB, HSS with UDM etc. But principles of the solution remains same. Similarly, the corresponding LTE procedures needs to be replaced by NR procedures, for example, Attach/TAU procedure with Registration Procedure/Registration procedure for mobility registration updating, Detach Procedure with Deregistration procedure and so on. But principles of the solution remains same.

The cause names in this embodiment are for illustration purpose and it can have any name. The Non Access Stratum (NAS) messages and Access Stratum (AS) messages described in this embodiment is only for illustration purpose it can be any NAS or AS messages as per defined protocol between UE and AMF/MME or UE and gNB (NG-RAN/any RAN node)/eNB.

The solutions and procedures defined in this embodiment are illustrated using 5G or LTE as an example. It could be any applicable for any RAT(s)/Access but the core principles remains the same.

As used herein, a “temporary forbidden PLMN list” refers to a list of Public Land Mobile Networks (PLMNs) stored at the UE. The list indicates the PLMNs the UE is temporarily configured to avoid camping or registering. The list indicates the list of PLMN(s) which are not a part of allowable PLMN(s) of the UE. The UE may not allowed to register or attach to the list of the PLMN(s) which are a part of “temporary forbidden PLMN list” for normal services.

As used herein, the back-off timer in the 3GPP standard is a mechanism used to control the frequency of retransmissions in a wireless communication system. The back-off timer is mainly utilized to alleviate the overload of the Mobility Management Entity (MME) or AMF or a RAN entity (for example, g-NodeB or NG-RAN or eNodeB, etc.) and to resolve congestion at the Serving Gateway (S-GW), or the SMF or the UPF or/and the Packet Data Gateway (P-GW).

In an embodiment, the device may add the selected or the registered Network (for example, PLMN or RAT or Cell or any combination of these to any temporary back-off Network List or forbidden Network List or any back-off list) which may lead to delay in the acquisition of available NTN services

As used herein, an “allowable network” for the UE may be those Network(s) which are not a part of any of the back-off network list or a forbidden network list or a temporary back-off/forbidden Network list of the UE. It may refer to a network on which UE is allowed to camp or register to get normal or full services.

Acceptable Cell/Network: Acceptable cell/Network is the cell/Network that is not enough to be a suitable cell/Network, but meets the minimum condition at least to make an emergency call. The minimum conditions are:
a. The cell/Network is not barred
b. The cell/Network selection criteria is met

Suitable Cell/Network: The cell/Network that the UE may camp on for a normal service. The E-UTRA and UTRA Suitable Cell/Network criteria is defined in 3GPP TS 36.304 and NR Suitable Cell/Network criteria is defined in 3GPP TS 38.304

As used herein, the Non-3GPP Inter-Working Function (N3IWF) interface in the 5G SBA (Service Based Architecture) is responsible for interworking between untrusted non-3GPP networks and the 5G core. N3IWF facilitates seamless handover and uninterrupted connectivity for users when they transition between different network types.

As used herein, the Evolved Packet Data Gateway (ePDG) is responsible for interworking between the Evolved Packet Core (EPC) and untrusted non-3GPP networks that require secure access, such as Wi-Fi, Long-Term Evolution (LTE) metro, and femtocell access networks.

In an embodiment, the UE determines the Last Registered Network by using at least one of: one or more of a value or a file or a configuration or an information configured or stored in the UE (for example, a Last registered Network value derived or stored in the UE or a last registered PLMN value (for example, RPLMN) stored or derived in the UE), one or more of a value or a file or a configuration or an information configured or stored in the SIM, one or more of a value or a file or a configuration or an information configured by the network, one or more of a value or a file or a configuration or an information configured by the server, one or more of a value or a file or a configuration or an information configured by an application function, a value configured in the SIM, a value stored in or derived from one or more of a EF_EPSLOCI file or a EF_LOCI file or a EF_PSLOCI file or a EF5GS3GPPLOCI file (or any other file or value stored or derived from) in the SIM (for example, the value stored in the above file may refer to some other value from which UE can derive the value of the RPLMN or the last registered network), a value stored in the non-volatile memory of the device and a file stored in the SIM

As used herein, the term “network” may refer to one or more of a Public Land Mobile Network (PLMN) or a Radio Access Technology (RAT) or an access or a system or a Radio Access Network (RAN) or a band or a frequency or a cell or a Network entity or a Network function or any Terrestrial Network or any Non-Terrestrial Network or any component of the network.

As used herein, the term “Non-Terrestrial Network (NTN)” may refer to one or more of a non-terrestrial PLMN or a non-terrestrial RAT or a non-terrestrial access or a non-terrestrial system or a non-terrestrial RAN or a non-terrestrial band or a non-terrestrial frequency or a non-terrestrial cell or a non-terrestrial Network entity or a non-terrestrial CN entity or a non-terrestrial network function or a component of a non-terrestrial network or a network other than TN or a network on Satellite Access Network.

As used herein, the term “Terrestrial Network (TN)” may refer to one or more of a terrestrial PLMN or a terrestrial RAT or a terrestrial access or a terrestrial system or a terrestrial RAN or a terrestrial band or a terrestrial frequency or a terrestrial cell or a terrestrial Network entity or a terrestrial CN entity or a terrestrial network entity or a component of terrestrial network or a terrestrial network function or a terrestrial network function or a component of a terrestrial network or a Network other than NTN or a network other than Satellite Access Network.

As used herein, the term “User Equipment (UE)” may refer to one or more of an NTN-capable UE or a UE capable of availing a NTN service or a UE supporting NTN technology or a UE capable of getting NTN services using technologies other than NTN technology or a UE capable of availing a NTN service which is deployed using a 3rd Generation Partnership Project (3GPP) Satellite or NTN system or a UE capable of availing a service which is deployed using a 3GPP system or a UE capable of availing a NTN service which is deployed using a NTN Network deployed using any 3GPP technology or a UE capable of availing a NTN service which is deployed using any proprietary NTN implementation outside the scope of 3GPP NTN system or a UE having a usage setting as a voice centric UE or a UE configured to send or to receive Attach Type as Combined International Mobile Subscriber Identity (IMSI) or a UE configured to send or to receive Attach Type as Combined IMSI with SMS only.

As used herein, “camping” or “registering” to a network or network cell refers to the process by which a UE (for example, a mobile phone or tablet or the like) connects to a specific cellular network and becomes associated with that network. It may also refer to a procedure where the UE has completed the cell/Network selection/reselection process and has chosen a cell/Network from which it plans to receive all available services. It may also refer to a process of selecting a cell of the PLMN/Network and doing any necessary procedures (for example, Location Registration) to avail services from the Network.

As used herein, the N1 mode refers to the standalone mode with a direct connection between the 5G Radio Access Network (RAN) and 5G Core Network (CN). In the N1 mode, the NG interface is used between RAN and 5GCN.

As used herein, the S1 mode is associated with the Evolved Packet System (EPS) and uses the 4G core network. In S1 mode, the 4G S1 interface is used between RAN and EPC.

The solutions defined in this embodiment are defined using PLMN selection or Network search as an example but it can refer to any of the Network Selection or Search procedures (for example, Cell Selection/Search, RAT selection/search, PLMN Selection/Search, etc.).

The terms, searching, scanning, selecting, registering, attaching, initiating Tracking Area Update (TAU) and camping, have been used interchangeable and may have same meaning.

As used herein, Packet Switching (PS) mode and Circuit Switching (CS) mode are the two different types of traffic modes that devices (or UEs) can use to access the network.

For a 5G system with satellite access, the following requirements apply:

The 5G system shall support service continuity between NR terrestrial access network and NR satellite access networks owned by the same operator or owned by 2 different operators having an agreement.

The NTN and TN could either operate in two different frequency bands (e.g. FR1 vs FR2), or in same frequency band (e.g. FR1 or FR2).

The terms, Satellite 3GPP access, Satellite access, Satellite Access Network, NR Satellite Access Network, Satellite NG-RAN Access Technology and NR Satellite access, have been interchangeably used and may have the same meaning.

The methods, issues or solutions disclosed in this embodiment are explained using NR satellite access or Satellite NG-RAN Access Technology as an example and is not restricted or limited to NR Satellite access only. However, the solutions proposed in this embodiment are also applicable for Satellite E-UTRAN access Technology, NB (Narrow Band)-S1 mode or WB (Wide Band)-S1 mode via satellite E-UTRAN access and/or NB-IOT (NarrowBand Internet Of Things) or WB-IOT (WideBand Internet Of Things) Satellite Access/Architecture.

The solutions which are defined for NR (5GC) are also applicable to legacy RATs like E-UTRA/LTE, the corresponding CN entities needs to be replaced by LTE entities for example, AMF with MME, g-NodeB with e-NodeB, UDM with HSS etc. But principles of the solution remains same.

An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The Network used in this embodiment is explained using any 5G Core Network Function, for example, AMF. However, the network could be any 5G/E-UTRAN Core Network Entities like AMF/SMF/MME/UPF or the Network could be any 5G/E-UTRAN RAN Entity like eNodeB (eNB) or gNodeB (gNB) or NG-RAN etc.

The messages used or indicated in this embodiment are shown as an example. The messages could be any signaling messages between UE and the Network Functions/Entities or between different Network functions/entities.

The term area/location/geographical area are used in this embodiment may refer to any of cell/cell ID, TAC/TAI, PLMN, MCC/MNC, Latitude/longitude, CAG cell or any geographical location/coordinate.

The terms, UE and MS, are used interchangeably in this embodiment and may have the same meaning.

The solutions explained in this embodiment are applicable to any (but not limited to) of the RAT(s) as defined in this embodiment.

The Network used in this embodiment could be any 5G/E-UTRAN Core Network Entities like AMF/SMF/MME/UPF or the Network could be any (but not limited to) 5G/E-UTRAN RAN Entity like eNodeB (eNB) or gNodeB (gNB) or NG-RAN etc.

The methods, issues or solutions disclosed in this embodiment are explained using NR access or NG-RAN Access Technology as an example and is not restricted or limited to NR access only. However, the solutions proposed in this embodiment are also applicable for E-UTRAN access Technology, NB (Narrow Band)-S1 mode or WB (Wide Band)-S1 mode via E-UTRAN access and/or NB-IOT (NarrowBand Internet Of Things) or WB-IOT (WideBand Internet Of Things) Access/Architecture.

The solutions which are defined for NR (5GC) are also applicable to legacy RATs like E-UTRA/LTE, the corresponding CN entities needs to be replaced by LTE entities for example, AMF with MME, g-NodeB with e-NodeB, UDM with HSS etc. But principles of the solution remains same.

The Network used in this embodiment is explained using any 5G Core Network Function for example, AMF. However, the network could be any 5G/E-UTRAN Core Network Entities like AMF/SMF/MME/UPF or the Network could be any 5G/E-UTRAN RAN Entity like eNodeB (eNB) or gNodeB (gNB) or NG-RAN etc.

The messages used or indicated in this embodiment are shown as an example. The messages could be any signaling messages between UE and the Network Functions/Entities or between different Network functions/entities.

The terms, camp and register, are used interchangeably and may have the same meaning.

The terms, wait timer, DisCo wait timer, Discontinuous Coverage wait timer, Random timer, Random wait timer, DCW Timer, are all used interchangeably and may have the same meaning.

The term disable the SIM(s) in this embodiment may mean that the UE is not enabling any network scanning on that SIM(s) (for ex—by either disabling the SIM Card operations completely, or by adding the current/available network(s) on that SIM Card(s) to a temporary forbidden network list (for example, temporary forbidden PLMN list), or by not scanning any allowable network(s) on that SIM Card(s)).

The term enable the SIM(s) in this embodiment may mean that the UE is enabling any network scanning on that SIM(s) (for ex—by either enabling the SIM Card operations, or by removing the current/available network(s) on that SIM Card(s) from a temporary forbidden network list (for example, temporary forbidden PLMN list), or by scanning any allowable network(s) on that SIM Card(s)).

The terms, wait range, Disco Wait Range, Discontinuous Coverage Wait Range, DCW Range, are all used interchangeably and may have the same meaning.

The term area as used in this embodiment may refer to any of cell/cell ID, TAC/TAI, PLMN, MCC/MNC, Latitude/longitude, any CAG/CAG identifier or any geographical location/coordinate.

For the list of possible NAS messages please refer to 3GPP TS 24.501 or 3GPP TS 24.301, for list of AS messages please refer to 3GPP TS 38.331 or 3GPP TS 36.331

The cause names in this embodiment are for illustration purpose and it can have any name. The Non Access Stratum (NAS) messages and Access Stratum (AS) messages described in this embodiment is only for illustration purpose it can be any NAS or AS messages as per defined protocol between UE and AMF/MME or UE and gNB (NG-RAN/any RAN node)/eNB.

According to 3GPP TR 24.821, SA3-LI has established the requirement that the network takes any laws and regulation for the area it serves into account to determine whether enforcement of the use of a Core Network in the country where the UE is physically located is required or not. From the UE point of view, it implies that, if the UE is capable to determine that a PLMN is allowed in the country of the UE location, the UE should select such PLMN.

Due to this requirement, cause value such as Cause #78 “PLMNs not allowed to operate at the present UE location” was introduced in the specifications.

According to 3GPP TS 23.501 (Rel-17): In order to ensure that the regulatory requirements are met, the network may be configured to enforce that the selected PLMN is allowed to operate in the current UE location by verifying the UE location during Mobility Management and Session Management procedures. In this case, when the AMF receives a NGAP message containing User Location Information for a UE using NR satellite access, the AMF may decide to verify the UE location. If the AMF determines based on the Selected PLMN ID and ULI (including Cell ID) received from the gNB that it is not allowed to operate at the present UE location the AMF should reject any NAS request with a suitable cause value. If the UE is already registered to the network when the AMF determines that it is not allowed to operate at the present UE location, the AMF may initiate deregistration of the UE. The AMF should not reject the request or deregister the UE unless it has sufficiently accurate UE location information to determine that the UE is located in a geographical area where the PLMN is not allowed to operate.

According to 3GPP TS 24.501 (Rel-17): To prevent repeated attempts to obtain service on a PLMN through satellite NG-RAN access technology, when the MS or the UE receives an integrity protected reject message with cause value #78 “PLMNs not allowed to operate at the present UE location” from a satellite NG-RAN cell, the UE or the MS maintains a list of “PLMNs not allowed to operate at the present UE location” in which it stores the PLMN ID of the rejecting PLMN, the current geographical location and a timer. An entry in the list is deleted if the timer associated to the entry expires or the UE successfully registers to the PLMN stored in the entry.

For 3GPP satellite NG-RAN, the UE shall store a list of “PLMNs not allowed to operate at the present UE location”. Each entry includes:
a) the PLMN identity of the PLMN which sent a message including 5GMM cause value #78 “PLMN not allowed to operate at the present UE location” via satellite NG-RAN access technology; and
b) the geographical location, if known by the UE, where 5GMM cause value #78 was received on satellite NG-RAN access technology; and
c) if the geographical location exists, a UE implementation specific distance value. The UE implementation specific distance value shall not be set to a value smaller than the value indicated by the network, if any.

The UE is allowed to attempt to access a PLMN via satellite NG-RAN access technology which is part of the list of “PLMNs not allowed to operate at the present UE location” only if:
a) the current UE location is known, a geographical location is stored for the entry of this PLMN, and the distance to the current UE location is larger than a UE implementation specific value. This UE implementation specific value shall not be set to a value smaller than the value indicated by the network, if any;
b) the timer associated with the entry of this PLMN has expired; or
c) the access is for emergency services.

### From 3GPP TS 23.501 (Rel-18)

### 5.4.1.4 Support of Unavailability Period

Before the start of an event that makes the UE unavailable, the UE includes an indication and type of unavailability, the Start of the Unavailability Period if known and the Unavailability Period Duration if known and triggers either Mobility Registration Update or UE initiated Deregistration procedure.

### 5.4.13.1 Mobility Management and Power Saving Optimization

For NR satellite access that provides discontinuous network coverage, and in case both UE and network indicate support for “Unavailability Period Support”, the following applies:

If the UE determines it will lose coverage and decides to remain in no service during coverage lose period, then:
a UE out-of-coverage period may be determined, which expressed by a Start of Unavailability Period and/or Unavailability Period Duration indicating the timing information for when a UE is expected to be out of coverage, and when the UE is expected to re-gain coverage again. The UE out-of-coverage period may consider current and expected future locations of the UE.

### From 3GPP TS 23.502 (Rel-18)

### 4.2.2.2.2 General Registration

1. UE to (R)AN: AN message (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [LADN DNN(s) or Indicator Of Requesting LADN Information], [NAS message container], [Support for restriction of use of Enhanced Coverage], [Preferred Network Behaviour], [UE paging probability information], [Paging Subgrouping Support Indication], [UE Policy Container (the list of PSIs, indication of UE support for ANDSP, the operating system identifier, Indication of URSP Provisioning Support in EPS, UE capability of supporting to report URSP rule enforcement to network)] and [UE Radio Capability ID], [Release Request indication], [Paging Restriction Information], PEI, [PLMN with Disaster Condition], [Requested Periodic Update time], [Unavailability Period Duration], [Start of Unavailability Period], [Unavailability Type])).

AMF provides start of unavailability period and Unavailability Period Duration to the UE in Registration Accept:
21. New AMF to UE: Registration Accept (5G-GUTI, Registration Area, [Mobility restrictions], [PDU Session status], [Allowed NSSAI], [Mapping Of Allowed NSSAI], [Configured NSSAI for the Serving PLMN], [Mapping Of Configured NSSAI], [NSSRG Information], [NSAG Information], [rejected S-NSSAIs], [Pending NSSAI], [Mapping Of Pending NSSAI], [Periodic Registration Update timer], [Active Time], [Strictly Periodic Registration Timer Indication], [LADN Information], [accepted MICO mode], [IMS Voice over PS session supported Indication], [Emergency Service Support indicator], [Accepted DRX parameters for E-UTRA and NR], [Accepted DRX parameters for NB-IoT], [extended idle mode DRX parameters], [Paging Time Window], [Network support of Interworking without N26], [Access Stratum Connection Establishment NSSAI Inclusion Mode], [Network Slicing Subscription Change Indication], [Operator-defined access category definitions], [List of equivalent PLMNs], [Enhanced Coverage Restricted information], [Supported Network Behaviour], [Service Gap Time], [PLMN-assigned UE Radio Capability ID], [PLMN-assigned UE Radio Capability ID deletion], [WUS Assistance Information], [AMF PEIPS Assistance Information], [Truncated 5G-S-TMSI Configuration], [Connection Release Supported], [Paging Cause Indication for Voice Service Supported], [Paging Restriction Supported], [Reject Paging Request Supported], [Paging Restriction Information acceptance/rejection], [“List of PLMN(s) to be used in Disaster Condition”], [Disaster Roaming wait range information], [Disaster Return wait range information], [Forbidden TAI(s)], [List of equivalent SNPNs], [Registered NID], [Unavailability Period Supported], [Discontinuous Coverage Supported], [Return To Coverage Notification Not Required], [Unavailability Period Duration], [Start of Unavailability Period]).

In recent years, devices support both NTN and TN services and have multiple SIMs and to access TN services and NTN services, the devices may scan for respective TN and NTN bands. In such scenarios, when UE is in remote or unpopulated areas where TN coverage is not extensive, the UE constantly scans for the TN coverage even after determining unavailability of TN coverage multiple times resulting in faster draining of power leading to faster battery drain of the UE as the UE consumes more battery while constantly scanning for the TN coverage.

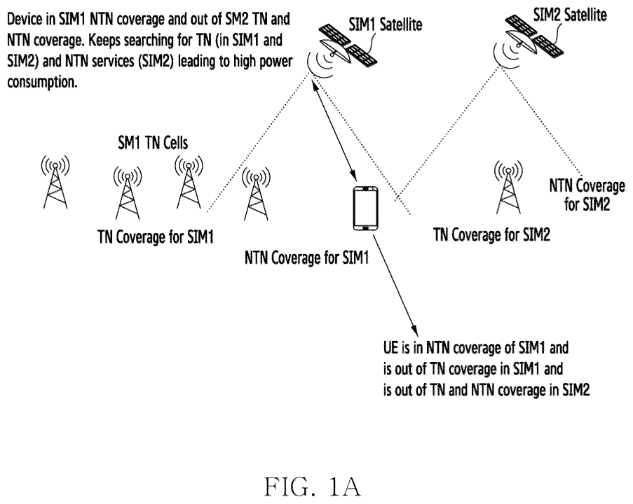

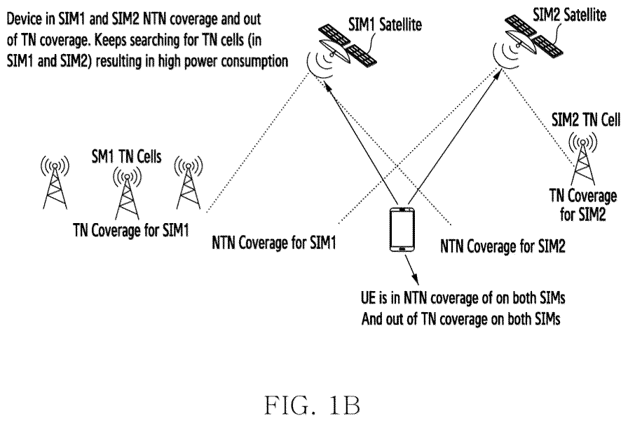

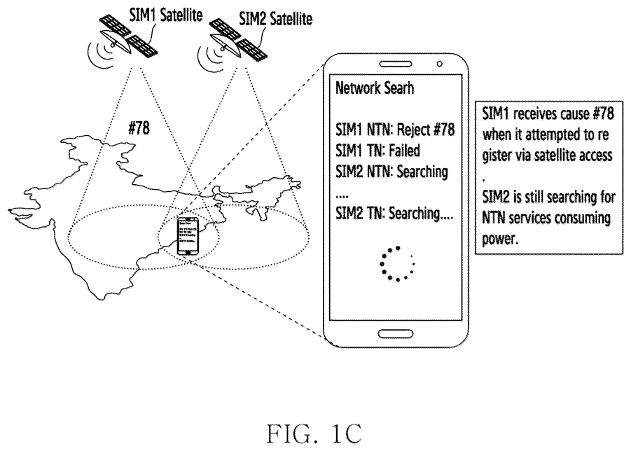

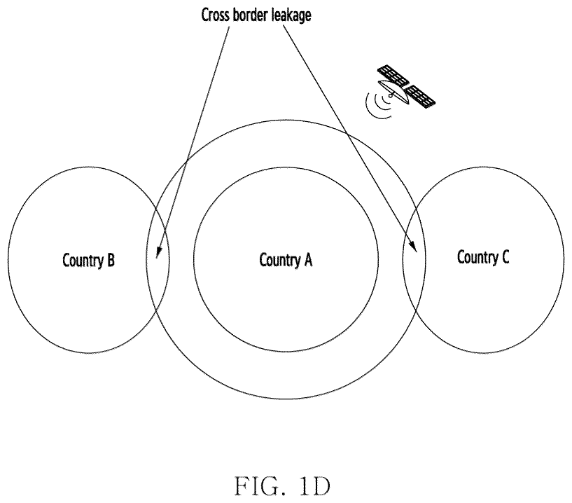

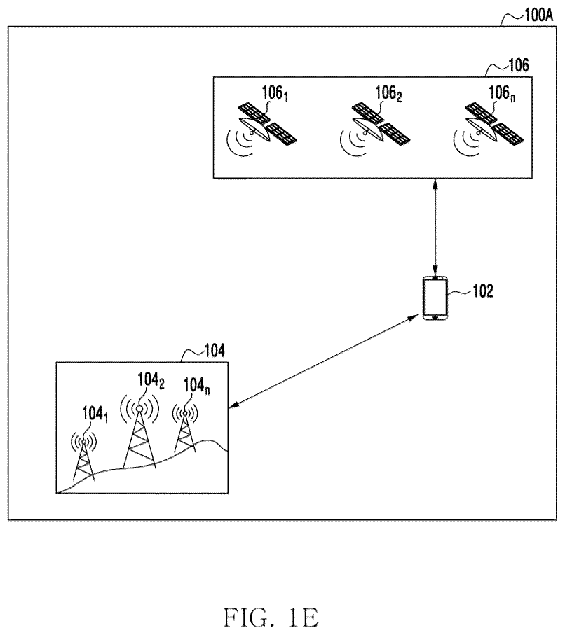

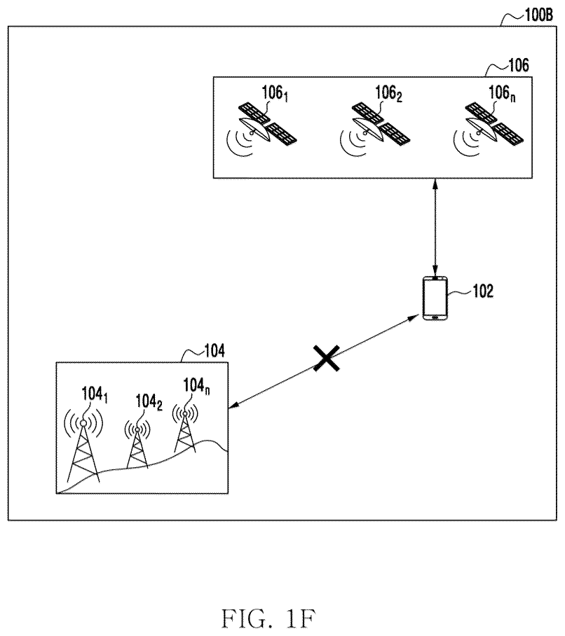

For instance, in remote areas (like deserts, hilly terrains, forests which are unpopulated and thus mobile network operators might not deploy cells in such areas), cellular coverage (of Terrestrial Networks (TN)) may be limited/not available. Whereas, NTN Cellular coverage might be available in some areas, for specific durations as per Satellite trajectory (ephemeris). In Dual/Multi SIM devices, whenever device is in remote area, both/all the SIM Card(s) may be searching for the service at regular intervals. However, service might not be available for both the SIM Card(s) or only NTN service might be available for one of the SIM Card(s). Device will not find any TN coverage in both the SIMs as it in remote area. But it would still be searching for cellular service (from TN/NTN) on both/all the SIM Cards leading to high power consumption. FIG. 1A depicts this exemplary problem scenario considering a device comprising two SIM cards.

In another scenario, in Dual/Multi SIM devices, whenever device is in remote area, both/all the SIM Card(s) would be searching for the service at regular intervals. However, only NTN service might be available for both/all of the SIM Card(s), or one/some of the SIM cards. NTN services might have different coverage availability than TN services. Even in such scenarios, device would still be searching for cellular service (from TN) on both the SIM cards leading to high power consumption. FIG. 1B depicts this exemplary problem scenario considering a device comprising two SIM cards.

In yet another scenario, in remote areas (like deserts, hilly terrains, forests) or border areas or international areas/water (Like Cruise etc.), cellular coverage (of Terrestrial Networks) may be limited/not available. NTN coverage might be available in some areas. However, there might be leakage of Satellite Signals of one Country/MCC into the other nearby areas/countries. In Dual/Multi SIM devices, whenever device is in the remote area, both/all the SIM Card(s) would be searching for the service at regular intervals. However, only NTN service might be available for both/all of the SIM Card(s). Network may reject the NTN services of one of the SIM Cards with cause value such as 5GMM Cause #78 (“PLMNs not allowed to operate at the present UE location”) due to regulatory reasons. However, device may still be searching for cellular service (TN/NTN) on other available SIM Cards, even though NTN services would be rejected, leading to high power consumption. FIG. 1C depicts this exemplary problem scenario considering a device comprising two SIM cards.

In order to solve the aforementioned problems, the present disclosure discloses a method of power management in a User Equipment (UE) including a plurality of Subscriber Identity Modules (SIMs). The method comprises enabling one of plurality of SIMs of the UE as a primary SIM when the UE is in a location with Non-Terrestrial Network (NTN) only coverage. The primary SIM scans for availability of Terrestrial Network (TN) coverage. Further, the method comprises disabling, by the UE, one or more of the plurality of SIMs of the UE while the primary SIM scans for TN coverage. The one or more of the plurality of SIMs are different from the primary SIM. Thereafter, the method comprises enabling, by the UE, the one or more of the plurality of SIMs of the UE upon detecting the availability of the TN coverage in response to scanning by the primary SIM. Hence, the present disclosure may be configured to save battery power in remote areas when the TN coverage is not extensive or completely absent.

In an embodiment, the present disclosure addresses one or more of the aforementioned problems in scenarios when the device is in a remote or unpopulated area, where no Terrestrial Network (TN) Cells are available, and one or any number of the SIMs may have NTN coverage, by enabling the device (also referred as UE in the present disclosure) to identify or decide which SIM should be designated as a primary SIM (if multiple SIMs of the UE are having NTN coverage). In some embodiments, the primary SIM may be decided based on the UE's primary SIM setting (based on user preference). Alternatively, the primary SIM may be decided using any one or combinations of the factors that may include, but not limited to, number of TN bands supported by each SIM (stack), current NTN coverage status (i.e., which SIM has NTN coverage) or Network availability for NTN services for the SIM Cards based on Network Broadcast per SIM Card (based on Rel-17 parameters EphemerisInfo, ntn-Config, t-Service, distanceThresh etc. parameters present in SIB19, or t-ServiceStart present in SIB32), Network/Device Indication for entering discontinuous coverage (for example, using a Leaving Coverage Notification), UE's Trajectory/Mobility Patterns (using GPS coordinates or using GNSS), operator's charging and subscription policy (NTN services prices for each SIM Card), user's usage history of all the SIMs in the UE, duration and start of discontinuous coverage (i.e., based on Rel-18 parameters determined by the UE or indicated by the network like start of unavailability period and unavailability period duration).

Upon deciding the primary SIM by the UE, the UE disables the secondary SIM/other SIMs and keeps only primary SIM as active. The UE continues to search for TN cells using the primary SIM. If any TN cell is detected, the device may know that the UE has moved out of remote area. In some embodiments, as an enhancement, the UE may append the Bands supported on other SIMs (which are not supported on primary SIM) to the Primary SIM stack, which helps the UE to not miss the cells on Bands only supported by other SIM cards.

In another scenario, the UE may receive a reject from a Satellite with Cause #78: (PLMN not allowed to operate at the present UE location) for any of the SIM Cards. Upon receiving the rejection due to Cause #78, the UE disables NTN services for both/all the SIM cards which have the same MCC as it knows that PLMNs belonging to the same MCC are not allowed to service at the location of the UE (since the UE is outside the location of the MCC of the NTN subscription and would get reject on all the SIMs if tried registering). The UE re-enables the NTN services once the timer associated with Cause #78 expires, or the UE moves a distance more than the value received in the Reject with cause #78 from the network.

In one embodiment, the UE may determine it is in remote/unpopulated area when the device has no TN service on the plurality of SIM cards after scanning all the bands of all TN RATs supported by the UE (pre-condition). The UE may then disable the SIM Card services of one (Dual SIM Case)/all (for multi-SIM case) of the SIM Card(s) which are in no service except the primary SIM Card (which is already in NTN service) and would only keep the primary SIM Card active. The UE would continue to monitor/search for cellular service (TN/NTN) using the primary SIM Card which is already active. Upon detecting availability of any cellular coverage (TN) using the active SIM Card, UE would enable other available SIM Card(s) and trigger search for service. If still UE fails to find cellular coverage on the other SIM Cards, UE would put those SIM Cards to sleep/disable them again and enable them when cellular coverage is detected next or at any regular time interval (if cellular coverage is continuously detected using active SIM Card). Detecting cellular coverage on active SIM Card enables the UE to identify that UE is back from the remote coverage and availability of service. Similarly, turning off or putting to sleep or disabling search for service on other or inactive or non-primary SIM Cards enable the UE to save a lot of power/battery which is unnecessarily wasted when service is not available. The UE may additionally append bands or frequencies or RATs of the inactive SIM Card(s) in the search list while triggering a search using primary or active SIM Card. This would even enable the device to identify if the related service for inactive SIM Card(s) are available or not. Radio Frequency switching would be avoided between the SIM Cards for cell search and hence power consumption is optimized. Also, search could be triggered using background scan or higher priority scan or intermediate scans. Therefore, the present disclosure enables the device to save power/battery during cell/service search in remote areas.

In another embodiment, when dual/multi SIM device is in remote area and only NTN service is available for both/all of the SIM Card(s) in the UE, but no TN service is available (pre-condition), the UE may determine which among the available NTN service (from the available SIM Cards) shall be selected or treated as primary NTN service for usage. The decision for primary NTN service may be based on various parameters that may include, but not limited to, Type of NTN Service/RAT (LEO, MEO, GEO, HAPS etc.) available for the SIM Cards and Number of TN bands supported by each SIM (stack), current NTN coverage status (for instance, which SIM has NTN coverage) or network availability for NTN services for the SIM Cards based on Network Broadcast per SIM Card (based on EphemerisInfo, ntn-Config, t-Service, distanceThresh etc. parameters present in SIB19, or t-ServiceStart present in SIB32), Network/Device Indication for entering discontinuous coverage (for example, using a Leaving Coverage Notification), device's Trajectory/Mobility Patterns (using GPS coordinates or using GNSS), signal/channel conditions (such as RSRP, SINR, CQI etc.), operator's charging and subscription policy (NTN services prices for each SIM Card), user's usage history of all the SIMs in the UE, Start of Unavailability Period and Unavailability Period Duration received from AMF in Registration Accept message. Based on these parameters, the UE may decide which NTN service has to be prioritized and selected as Primary SIM Card. The UE may thereafter disable the remaining SIM Cards until TN cellular coverage is detected using primary SIM Card (as explained in the earlier embodiment described in above paragraph). The present disclosure enables the device to save power/battery during cell/service search in remote areas as well as save cost by selecting the appropriate NTN services.

In yet another embodiment, consider the UE has dual SIM Cards/Subscriptions from the same country (i.e. the MCC1 of SIM1 HomePLMN1 and MCC2 of SIM2 HomePLMN2 is same i.e. MCC1 and MCC2 is same), then the UE can avail NTN services from the Satellite Operators which are providing services for the MCC which belongs to SIM1 and SIM2. Initially, when any of the SIM Cards gets a Reject Cause #78 from the available Satellite operators broadcasting a particular MCC (which is same as the MCC of SIM(s)'s Home PLMN(s)) for the NTN service and there is no other satellite operators of any other MCC, the UE would determine that UE is at a location outside of the Home Serving Area/MCC. The Satellite may send reject cause #78 as due to regulatory reason (like the core network should be of the location country), the satellite may not be allowed to provide services for some PLMNs in certain locations. The UE may determine that there are no available Satellite operators which can provide NTN services to any of the SIM Cards. Based on above factors/reject cause, the UE may determine that the UE is not able to get NTN services for any of the SIM Cards. Thereafter, the UE may decide which NTN service has to be prioritized and selected as Primary SIM Card as explained previously in the above paragraph. Further, the UE may disable the remaining SIM Cards (for both TN and NTN services) and wait until the UE is able to detect any new Satellite Operator belonging to the home MCC or is able to register for any MCC/PLMN for NTN services without any reject causes. The UE may enable other SIM for NTN services if required or wait until TN cellular coverage is detected using primary SIM Card (as explained in Solution 1). The device may also disable all SIM cards and wait till the timer duration associated with reject cause #78 expires or UE moves a specific distance before enabling NTN service again. The UE may also detect if the UE location has changed from the location where it received cause #78 or if the UE implementation specific timer for Cause #78 has expired. Upon changing location or expiry or stop of timer, the UE may enable SIMs and check for NTN coverage. The present disclosure helps the device to save power/battery during cell/service search in remote/border areas as well as save cost by selecting the appropriate NTN services. The UE can still search for shared PLMNs (PLMNs with MCC Codes 9XX) and get services.

FIG. 1E shows an architecture diagram 100 for power management in a User Equipment (UE) 102 including a plurality of Subscriber Identity Modules (SIMs), in accordance with some embodiments of the present disclosure. FIG. 1F illustrates a scenario depicting unavailability of TN coverage in a new location, in accordance with some embodiments of the present disclosure.

The architecture 100 as indicated in the FIG. 1E includes the UE 102, Terrestrial Network (TN) device 1041-104N, (collectively referred as one or more TN devices 104), and Non Terrestrial Network (NTN) device 1061-106N, (collectively referred as one or more NTN devices 106).

In some embodiments, the UE 102 may be a dual SIM device. In some other embodiments, the UE 102 may be a multi-SIM device. In some embodiments, the UE 102 may receive network services from at least one of, but not limited to, the one or more TN devices 104, and the one or more NTN devices 106. The one or more TN devices 104 may provide terrestrial network services to the UE 102 by transmitting signals from a land based infrastructure. The one or more TN devices 104 may operate through components such as cables, Ethernets, wireless transmission systems and the like. The one or more NTN devices 106 are network devices that provide network services to the UE 102 through wireless communication systems that operate above surface of the earth, such as, satellites. In some embodiments, the UE 102 may rely on the one or more TN devices 104 such as base stations for receiving the terrestrial network services as shown in the FIG. 1A. In some other embodiments, the UE 102 may rely only on the one or more NTN devices 106 such as satellites for receiving the NTN services as shown in the FIG. 1E.

In some embodiments, as shown in the FIG. 1F, the UE 102 may be at a new location. This new location may not have TN services due to lack of physical infrastructure required for providing the TN services in the new location. The aforementioned scenario of unavailability of TN services is depicted with a cross mark as shown in the FIG. 1F. In such aforementioned scenario, the UE 102 may rely on the one or more NTN devices 106 for receiving the NTN services. The one or more NTN devices 106 may include, but not limited to, satellites.

In some embodiments, due to unavailability of TN services, plurality of scenarios may occur. In one scenario, one of the plurality of SIMs of the UE 102 may be detected with NTN coverage. In another scenario, each of the plurality of SIMs of the UE 102 or more than one SIM of the plurality of SIMs of the UE 102 may be detected with the NTN coverage. In yet another scenario, none of the SIMs of the UE 102 are detected with the NTN coverage (for example, due to unavailability of the NTN services or due to regulatory reasons of a location or due to any other reasons). In some embodiments, upon determining one of the plurality of scenarios have occurred, the UE 102 is configured to perform different functions for power management in the UE 102 as disclosed below.

In some embodiments, consider a scenario where only one of the plurality of SIMs is detected with the NTN coverage, then, the UE 102 may enable the SIM detected with NTN coverage as a primary SIM and disable rest of the SIMs of the UE 102 other than the primary SIM, temporarily. The primary SIM of the UE 102 may scan for the TN coverage continuously, periodically, upon detecting a change in the value of one or more of the predefined parameters or upon detecting a change in location of the UE 102 compared to a previously detected location of the UE 102. In some embodiments, while the primary SIM may be scanning for the TN coverage, the UE 102 may disable rest of the plurality of SIMs other than the primary SIM periodically at predefined time intervals. Alternatively, while the primary SIM may be scanning for the TN coverage, the UE may disable the rest of the plurality of SIMs other than primary SIM periodically for increasing time intervals up to a maximum time limit. Alternatively, the UE 102 may disable rest of the plurality of SIMs other than the primary SIM completely until the primary SIM (or in some scenarios one or more primary SIMs) detects availability of the TN coverage or there is a change in the values of one or more of the pre-defined parameters. For example, consider SIM1, SIM2, SIM3, and SIM4 are present in UE-1 and a user-1 of the UE-1 has moved to location A that has no TN services. In such an instance, SIM1 is detected with NTN coverage. Due to the aforementioned detection, the UE-1 disables the other SIMs. In some instances, the UE disables SIM2, SIM3, and SIM4 for a time interval of 2 hours and may enable SIM2, SIM3, and SIM4 for 30 minutes, periodically. In some other instances, the UE disables SIM2, SIM3, and SIM4 for a time interval of 1 hour initially and may enable SIM2, SIM3, and SIM4 for 30 minutes, then disable the SIM2, SIM3, and SIM4 for increased time interval of 2 hours and may enable SIM2, SIM3, and SIM4 for 30 minutes. In some other instances, the UE-1 disables SIM2, SIM3, and SIM4 until SIM 1 detects for availability of the TN coverage. Further, the primary SIM detects the TN coverage in response to scanning for the TN coverage. Thereafter, the UE-1 enables SIM2, SIM3 and SIM4 to their normal active state.

In some embodiments, consider another scenario more than one SIM among the plurality of SIMs has the NTN coverage, the UE 102 may enable one of the plurality of SIMs detected with the NTN coverage, the UE 102 may determine a SIM from the plurality of SIMs as the primary SIM based on one or more predefined parameters. The one or more predefined parameters may include, but not limited to, predefined settings of the UE 102, user preference, services used by the UE 102, Artificial Intelligence or Machine Learning based predicted parameters, number of TN and NTN bands supported by each of the plurality of SIMs, NTN coverage status for each of the plurality of SIMs, type of NTN services available for each of the plurality of SIMs, operator deployment for TN and NTN, operator charging and subscription policy, NTN coverage unavailability period duration and start of unavailability period for each of the plurality of SIMs, NTN store and forward (S&F) support or capability history of each of the plurality of the SIMs, S&F Data quota and S&F Data retention period for each of the plurality of the SIMs, usage history of each of the plurality of SIMs, signal or channel conditions or data throughput status of each of the plurality of SIMs, geo-fencing data of SIMs and the location and mobility status and patterns of the UE 102. For example, consider the UE2 comprises SIM5, SIM6 and SIM7 and each of the SIM5, SIM6 and SIM7 are detected with NTN coverage in location B where TN coverage is unavailable. Then, in the aforementioned instance, based on the aforementioned one or more predefined parameters UE2 determines SIM 7 has higher usage history in comparison with SIM5 and SIM6, and SIM 7 has higher NTN coverage status in comparison with SIM5 and SIM6. Hence, based on the aforementioned inference, UE2 determines SIM7 as the primary SIM.

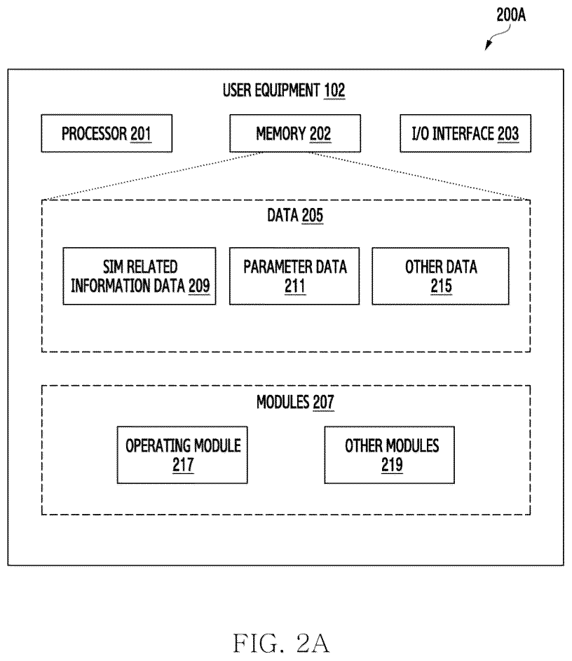

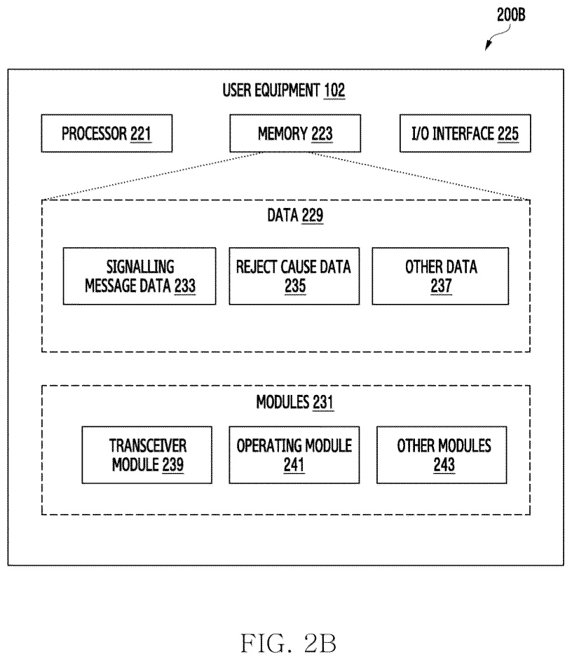

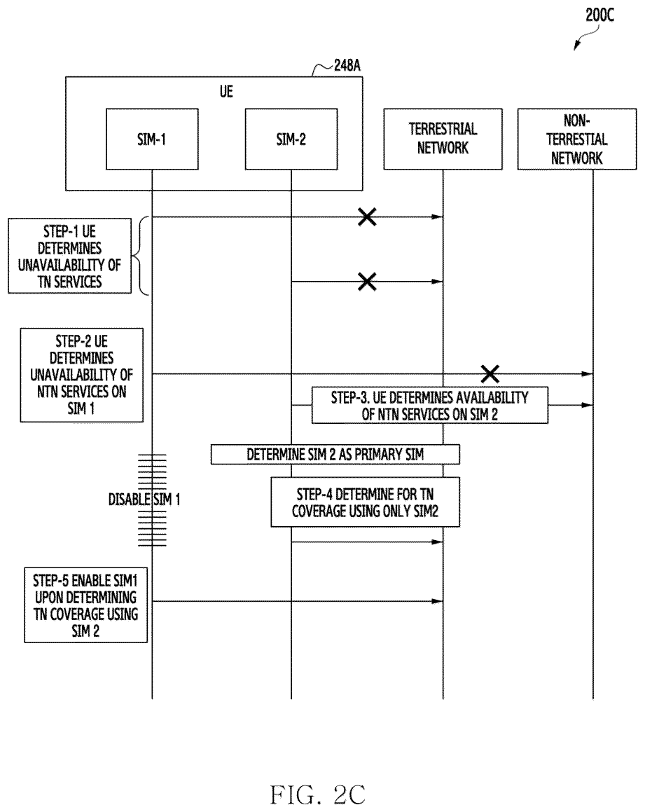

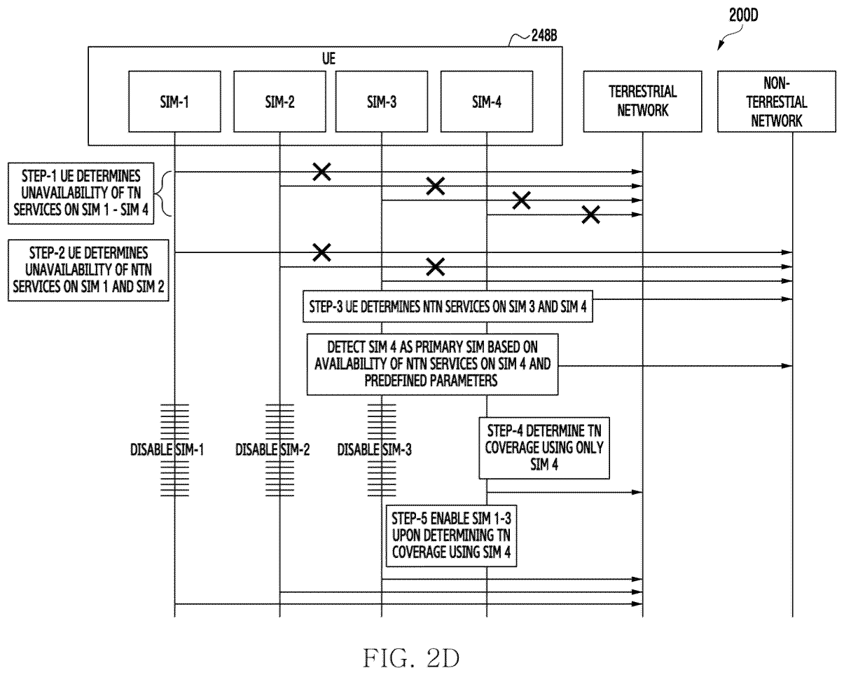

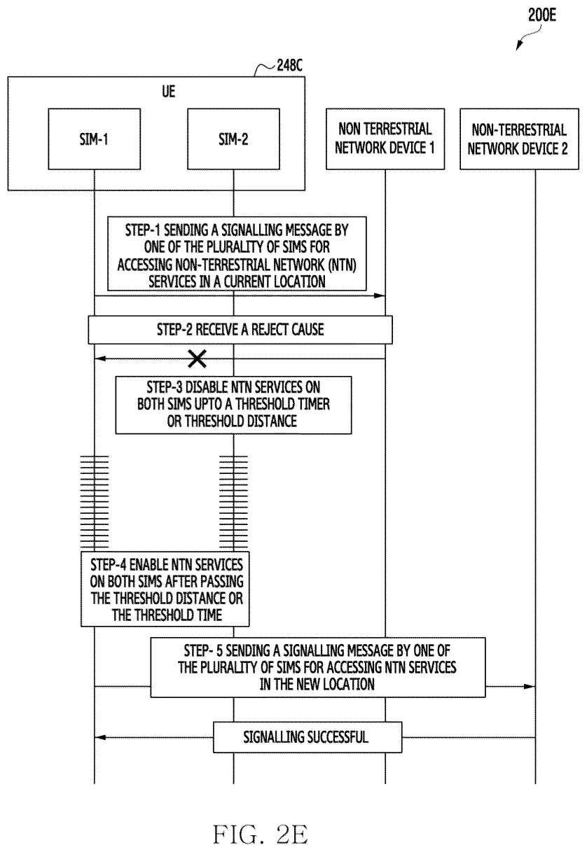

In some embodiments, consider a scenario where one or more of the plurality of the SIMs of the UE 102 are detected with the NTN coverage. In such scenarios, the UE 102 may receive a reject cause (for example, 5GMM Reject Cause #78 or EMM Reject Cause #78) due to regulatory reasons of a location upon sending a signaling message for one or more of the plurality of SIMs of the UE 102 to one or more NTN networks accessible in a current location for accessing Non-Terrestrial Network (NTN) services. The reject cause indicates inability to provide NTN services in the current location for the UE 102 from the one or more NTN networks for the one or more of the plurality of SIMs of the UE 102. The signaling message may be one of, but not limited to, an Access Stratum Signaling Message or a Non-Access Stratum Signaling Message. In such scenarios, the UE 102 may disable one or more of plurality of SIMs until an expiry of at least one preset condition indicated in the corresponding reject cause. In some embodiments, the one or more of the plurality of SIMs belong to a location or country (for example, same Mobile Country Code (MCC)) which is same as the home location of the one or more of the plurality of SIMs for which the reject cause is received. The preset condition may include, but not limited to, a threshold time, and a threshold distance to be covered from the current location of the UE 102 after which the corresponding SIM of the UE 102 can send the signaling message. In some instances, the UE 102 may disable the SIMs for scanning for NTN coverage and TN coverage until an expiry of at least one preset condition or in some other instances, the UE 102 may disable scanning for the NTN coverage while continuing scanning for the TN coverage. In some embodiments, the UE 102 may enable each of the plurality of SIMs of the UE 102 upon an expiry of the at least one preset condition and thereafter, the UE 102 may send a signaling message for each of the plurality of SIMs of the UE 102 to the one or more NTN networks 106 accessible for accessing the NTN services, upon enabling each of the plurality of SIMs of the UE 102. Detailed explanation of power management of the UE 102 is explained further in the present disclosure under FIGS. 2A-2E.

The procedure or methods explained in this embodiment are illustrated with enabling and disabling SIM Card(s) as an example. The procedure or methods for enabling the SIM Card(s) may mean that the UE is enabling any network scanning on that SIM(s) (for ex—by either enabling the SIM Card operations, or by removing the current/available network(s) on that SIM Card(s) from a temporary forbidden network list (for example, temporary forbidden PLMN list), or by scanning any allowable network(s) on that SIM Card(s)). The procedure or methods for disabling the SIM Card(s) may mean that the UE is not enabling any network scanning on that SIM(s) (for example, by either disabling the SIM Card operations completely, or by adding the current/available network(s) on that SIM Card(s) to a temporary forbidden network list (for example, temporary forbidden PLMN list), or by not scanning any allowable network(s) on that SIM Card(s)).

The procedure or methods explained in this embodiment are illustrated with scanning for TN services, enabling or disabling a plurality of SIM cards using one or more of: continuously, periodically, at certain pre-defined time intervals, at increased time intervals, based on change in location of the UE and when the primary SIM detects availability/unavailability of the TN coverage. However, the procedure or methods for scanning for TN services, enabling or disabling a plurality of SIM cards may also happen when the UE detects a change or change in the value of one or more of the predefined parameters as defined in this embodiment.

In an embodiment, when the UE disables the SIM Card(s) or doesn't allow a plurality of the SIM Card(s) to scan for any network, any configured services which are triggered by the UE or by the upper layers or by the user are fulfilled by or re-directed to the SIM Card(s) which is active/enabled in the UE or which is the Primary SIM or the chosen Primary SIM of the UE. All the default configuration of the services are set to the active/enabled/Primary SIM Card(s) of the UE.

FIG. 2A depicts a detailed block diagram 200A of power management in UE 102 including a plurality of SIMs, in accordance with some embodiments related to the present disclosure.

In some embodiments, the UE 102 may include a processor 201, an I/O interface 203 and a memory 202. The I/O interface 203 may be configured for receiving and transmitting an input signal or/and an output signal related to one or more operations of the UE 102. The memory 202 may be communicatively coupled to the processor 201 and one or more modules 207. The processor 201 may be configured to perform one or more functions of the UE 102 using data 205 and the one or more modules 207.

In an embodiment, the data 205 stored in the memory 202 may include without limitation, a SIM related data 209, parameter data 211, and other data 215. In some implementations, the data 205 may be stored within the memory 202 in the form of various data structures. Additionally, the data 205 may be organized using data models. The other data 215 may include various temporary data and files generated by the different components of the UE 102.

In some embodiments, the SIM related data 209 may include information on number of SIMs enabled at a given time in a location, SIMs selected as a primary SIM for a location, number of SIMs disabled based on change in location for a threshold time or threshold distance, cause for disabling SIMs at the location and the like. The primary SIM is utilized for scanning for TN coverage upon disabling all the other SIMs of the UE 102 in a location where NTN services are only available. The primary SIM scans for the TN coverage continuously, periodically or upon detecting a change in location of the UE 102 compared to a previously detected location. For example, the primary SIM scans for TN coverage upon moving from location A to location Z or once in ten hours. In some embodiments, for example, in a location A, only SIM1 of the UE among SIM1-SIM3 is detected with NTN coverage and no TN coverage, then in such a scenario, UE enables SIM1 and disables SIM2 and SIM3 for location A.

In some embodiments, the parameter data 211 stores the one or more predefined parameters for determining a SIM as the primary SIM in case more than one of the plurality of SIMs are detected with NTN coverage when there is unavailability of TN coverage in a location. The one or more predefined parameters may include, but not limited to predefined settings of the UE 102, user preference, services used by the UE 102, Artificial Intelligence or Machine Learning based predicted parameters, number of TN and NTN bands supported by each of the plurality of SIMs, NTN coverage status of each of the plurality of SIMs, type of NTN services available for each of the plurality of SIMs, operator deployment for TN and NTN, operator charging and subscription policy, NTN coverage unavailability period duration and start of unavailability period for each of the plurality of SIMs, NTN store and forward (S&F) support/capability history of each of the plurality of the SIMs, S&F Data quota and Data retention period for each of the plurality of the SIMs, usage history of each of the plurality of SIMs, signal or channel conditions or data throughput status of each of the plurality of SIMs, geo-fencing data of the SIMs, and the location and mobility status and pattern of the UE 102. For example, consider a scenario where SIM X and SIM Y of the UE4 are detected with the NTN coverage in a location B, then in such a scenario, the UE4 determines the SIM X as the primary SIM based on the one or more predefined parameters such as more availability period of SIM X over SIM Y in the location B, less operator charging and subscription policy in location B and the like. Furthermore, consider another scenario where SIM Z and SIM A of the UE4 has NTN coverage in a location C, then in such a scenario the UE4 determines SIM A as the primary SIM based on more number of TN bands supported by SIM A upon comparison with SIM Z, more NTN coverage status on SIM A availability when compared to SIM Z and the like as per the one or more predefined parameters.

For instance, the exemplary parameter data 211 (that may be used to decide the primary SIM) may include, but not limited to:
a. Using the device's primary SIM setting, or the default SIM used for Call and Data services by the user.
b. Number of TN bands supported by each SIM (stack). SIM1 might be supporting 10 bands and 2 NTN bands, whereas SIM2 might have 12 bands support along with 3 NTN bands support. SIM2 might be chosen in such cases.
c. Current NTN coverage status (which SIM has NTN coverage) or Network availability for NTN services for the SIM Cards based on Network Broadcast per SIM Card (based on for instance, EphemerisInfo, ntn-Config, t-Service, distanceThresh etc. parameters present in SIB19, or t-ServiceStart present in SIB32), Network/Device Indication for entering discontinuous coverage (for example, using a Leaving Coverage Notification), Device's Trajectory/Mobility Patterns (using GPS coordinates or using GNSS).
d. Operator's charging and subscription policy (NTN services prices for each SIM Card). SIml may have significant higher charges for NTN services than SIM1, due to which it may be desirable to use SIM2 in such cases.
e. User's usage history of all the SIMs in the device. User may be using any one of the SIMs primarily for all calls and services.
f. Service data of all the SIMs at the present UE location, i.e. what is the success rate and quality of services at the present UE location for all the SIMs.
g. Start of Unavailability Period and Unavailability Period Duration determined by the UE or received from AMF in Registration Accept message. For example, SIM1 might have start of unavailability period 1 hour away while SIM 2 may have 2 hour away. So SIM2 might be chosen as it can serve the user for longer before unavailability period starts.

In some embodiments, the data 205 may be processed by the one or more modules 207 of the UE 102. In an implementation, the one or more modules 207 may include, without limiting to, an operating module 217, and other modules 219. In an embodiment, the other modules 219 may be used to perform various miscellaneous functionalities of the UE 102. It will be appreciated that such one or more modules 207 may be represented as a single module or a combination of different modules.

In an example embodiment, the operating module 217 may be configured to enable one of plurality SIMs of the UE 102 as primary SIM when the UE 102 is in a location with no TN coverage.

In an example embodiment, for enabling the one of the plurality of SIMs of the UE 102 as the primary SIM, the operating module 217 may detect a number of SIMs among the plurality of SIMs of the UE 102 with NTN only coverage. When only one SIM among the plurality of SIMs of the UE 102 is detected with the NTN coverage, the operating module 217 may be configured to enable the SIM detected with the NTN coverage as the primary SIM.

In an example embodiment, when more than one SIM among the plurality of SIMs or none of the plurality of SIMs of the UE 102 is detected with the NTN coverage, the operating module 217 may be configured to enable one of the plurality of SIMs detected with the NTN coverage or no NTN coverage as the primary SIM based on the one or more predefined parameters.

In some embodiments, while the primary SIM scans for the TN coverage, the operating module 217 may be configured to disable the one or more of the plurality of SIMs other than the primary SIM, periodically, at predefined time intervals or disable the one or more of the plurality of SIMs other than the primary SIM until the primary SIM detects for availability of the TN coverage or until there is a change in the values of one or more of the pre-defined parameters. In some embodiments, more than one SIM may be designated as a primary SIM. In such scenarios, one or more of the plurality of SIMs other than the one or more primary SIMs may be disabled completely until the one or more primary SIM detects availability of the TN coverage or until there is a change in the values of one or more of the pre-defined parameters.

In some embodiments, disabling one or more of the plurality of SIMs other than primary SIM of the UE may be performed by adding the NTN PLMN of one or more of the plurality of SIMs to forbidden PLMN list of the UE 102. Alternatively, disabling one or more of the plurality of SIMs other than primary SIM of the UE may be performed by adding the NTN and TN PLMNs of one or more of the plurality of SIMs to forbidden PLMN list of the UE 102. When a PLMN is added to a forbidden PLMN list, it equivalent PLMNs may also be added to the forbidden PLMN list.

In some embodiments, scanning for the TN coverage may be based on scanning for an identifier corresponding to one or more predefined network coverage parameters comprising at least one of, but not limited to, frequency, a wavelength band, a network cell, a Public Land Mobile Network (PLMN) of the TN network.

In some embodiments, upon detecting the availability of the TN coverage in response to scanning by the primary SIM, the operating module 217 may be configured to enable the one or more of the plurality of SIMs of the UE 102. In some embodiments, the operating module 217 may be configured to enable each of the plurality of SIMs in the UE 102 or the operating module 217 may be configured to enable one or more SIMs of the plurality of SIMs related to which one or more predefined network coverage parameters are detected during scanning by the primary SIM. The one or more SIMs of the plurality of SIMs that are enabled proceed to scan for the TN coverage or the NTN coverage.

In some embodiments, enabling one or more of the plurality of SIMs may be performed by removing the NTN and TN PLMNs of the one or more of the plurality of SIMs from the forbidden PLMN list of the UE 102. When a PLMN is removed from a forbidden PLMN list, it equivalent PLMNs may also be removed from the forbidden PLMN list.

FIG. 2B depicts a detailed block diagram 200B of power management in a UE 102 including a plurality of SIMs, in accordance with some embodiments related to the present disclosure.

In some embodiments, the UE 102 may include a processor 221, an I/O interface 225 and a memory 223. The I/O interface 225 may be configured for receiving and transmitting an input signal or/and an output signal related to one or more operations of the UE 102. The memory 223 may be communicatively coupled to the processor 221 and one or more modules 231. The processor 221 may be configured to perform one or more functions of the UE 102 using data 229 and the one or more modules 231.

In an embodiment, the data 229 stored in the memory 223 may include without limitation, a signaling message data 233, reject cause data 235, and other data 237. In some implementations, the data 231 may be stored within the memory 223 in the form of various data structures. Additionally, the data 229 may be organized using data models. The other data 237 may include various temporary data and files generated by the different components of the UE 102.

The signaling message data 233 stores signaling messages sent by plurality of SIMs of the UE 102 for accessing the NTN services in a current location to NTN devices 106. This signaling message comprises information on number of NTN devices 106 available for providing NTN services in a current location. For example, at location X, five SIMs of the UE 102 have shared signaling message to NTN device and NTN device2 and two SIMs of the UE 102 have shared the signaling message to NTN device1 and NTN device 3. This aforementioned example provides an inference that three NTN devices are available to provide NTN services in the current location. In some embodiments, the signaling message may be one of an Access Stratum Signaling Message or Non-Access Stratum Signaling message.

The reject cause data 235 stores responses received indicating a reject cause from corresponding one or more NTN devices 106 for providing NTN services in a location. The reject cause indicates inability to provide NTN services in the current location of the UE 102 for accessing NTN services (for example, A signaling reject message or Registration Reject message or Attach Reject message or TAU reject message or any AS/NAS signaling reject message or 5GMM Reject Cause or EMM Reject Cause (for example, Reject Cause #78: PLMN not allowed to operate at present UE location). The preset condition may include, but not limited to, a threshold time after which the corresponding SIM of the UE 102 can send the signaling message, or a threshold distance to be covered from the current location of the UE 102 after which the corresponding SIM of the UE 102 can send the signaling message. For example, the threshold time is for 2 hours and the threshold distance covered from the current location of the UE 102 is 30 kilometers. Considering the aforementioned example, if UE 102 receives a reject cause Z in a location B, then, the UE 102 can send the signaling message after 2 hours or after crossing 30 kilometers from the location B.

In some embodiments, the data 229 may be processed by the one or more modules 231 of the UE 102. In an implementation, the one or more modules 231 may include, without limiting to, a transceiver module 239, an operating module 241 and other modules 243. In an embodiment, the other modules 243 may be used to perform various miscellaneous functionalities of the UE 102. It will be appreciated that such one or more modules 231 may be represented as a single module or a combination of different modules.

In some embodiments, when UE 102 detects the user associated with UE 102 has moved to a new location (also referred as current location), the transceiver module 239 may be configured to send a signaling message for one or more of the plurality of SIMs of the UE 102 to one or more NTN networks accessible in the current location of the UE 102 for accessing the NTN services in the current location.

In some embodiments, the transceiver module 239 may be configured to receive the reject cause (for example, 5GMM or EMM Reject Cause #78) indicating inability to provide NTN services in the current location.

In some embodiments, in response to receiving the reject cause from the one or more NTN networks, the operating module 241 may be configured to disable the one or more of plurality of SIMs of the UE 102 until an expiry of one preset condition indicated in the corresponding reject cause. The disabled one or more of the plurality of SIMs belong to a location which is same as the home location of the one or more of the plurality of SIMs for which the reject cause is received. In some embodiments, the operating module 241 may disable scanning for NTN coverage and TN coverage until an expiry of the at least one preset condition or the operating module 241 may disable scanning for the NTN coverage until an expiry of the at least one preset condition while scanning for the TN coverage continues to be active. In some embodiments, in a multi-SIM scenario for UE5, if SIM-1 receives a reject cause, then all the other SIM-1 of UE5 which belong to a location which is same as the home location of the SIM-1 may be disabled until the expiry of the preset condition. Alternatively, if more than one SIM of UE5 receives reject cause, then the UE5 may check when the reject cause was received and will apply the preset condition to the first SIM that received the reject cause.

In some embodiments, upon an expiry of the at least one preset condition indicated in the corresponding reject cause, the operating module 241 may be configured to enable each of the plurality of SIMs of the UE 102 and may be configured to send a signaling message for each of the plurality of SIMs of the UE 102 to the one or more NTN networks accessible for accessing the NTN services.

In some embodiments, upon successfully registering with one of the one or more NTN devices 106 for accessing the NTN services, the operating module 241 may be configured to determine a SIM from the one or more of the plurality of SIMs of the UE 102 for scanning for availability of TN coverage as disclosed in the FIG. 2A.

Henceforth, the process of power management of the UE 102 is explained with the help of one or more examples (200C-200E) for better understanding of the present disclosure as disclosed in FIG. 2C-FIG. 2E. However, the one or more examples should not be considered as limitation of the present disclosure.

Consider a scenario one illustrating a first example embodiment depicting a scenario as shown in FIG. 2C where only one SIM among the plurality of SIMs is detected with NTN services in a location A. At step one, UE 248A determines unavailability of TN services in the location A. At step two, the UE 248A determines unavailability of NTN services on SIM 1. At step three, the UE 248A determines availability of NTN only services on SIM 2, and determines SIM 2 as a primary SIM. The UE 248A disables TN and NTN services on SIM 1 upon determining SIM2 as the primary SIM. At step four, in response to scanning for the TN coverage by the SIM 2, the UE 248A determines the TN coverage. At step five, the UE 248A enables the TN and NTN services on SIM1. For example, the primary SIM scans for the TN coverage upon moving from location A to location Z once in two hours.

Consider a scenario two illustrating a second example embodiment depicting a scenario in a multi SIM device for power management in the UE 248B where plurality of SIMs are detected with the NTN coverage in a location B. At step one, the UE 248B determines unavailability of the TN services on SIM 1, SIM 2, SIM 3 and SIM 4. At step two, the UE 248B determines unavailability of NTN services on SIM1 and SIM2. At step three, the UE 248B determines availability of NTN services on SIM3 and SIM4. Since, plurality of SIMs of the UE 248B are determined with the NTN coverage, the UE 248B determines one of the plurality of SIMs of the UE 248B as the primary SIM based on predefined parameters. The UE 248B determines SIM four as the primary SIM based on more NTN coverage on SIM four when compared to the NTN coverage on SIM3, more usage history of SIM four in the UE 248B when compared to the usage history of SIM 2 in the UE 248B, and less operating charging and subscription policy in SIM four when compared to the operating charging and subscription policy in SIM 2 and the UE 248B disables NTN services on SIM1, SIM2 and SIM 3. At step four, in response to scanning for the TN coverage by SIM4, the UE 248B detects the TN coverage and the UE 248B enables the TN and NTN services on SIM1, SIM2 and SIM3 for accessing TN and NTN services in the location B.

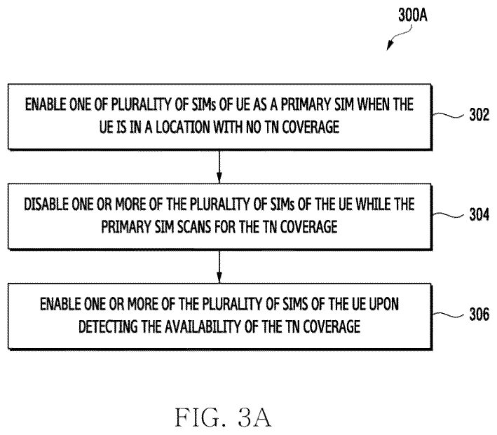

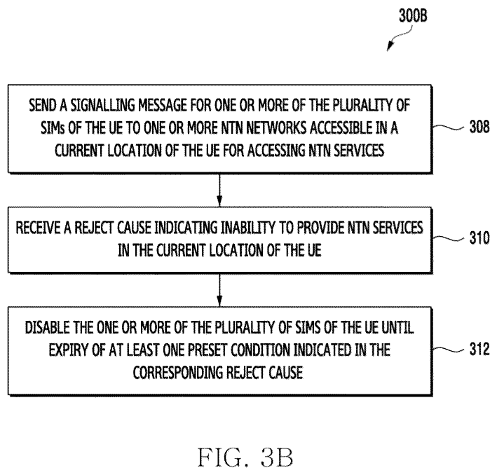

Consider a scenario three, illustrating a third example embodiment depicting a scenario of power management where UE 248C receives a reject cause due to regulatory reasons in a location C. In some embodiments, such scenario 3 occurs, when the SIMs sending the signaling messages are registered with in a home country A, which is different from location of a country B at which the NTN services are requested. As the NTN services may be accessible only by SIMs registered in the country B due to regulatory reasons, when SIMs registered in country A send a signaling message for accessing the NTN services, a reject cause is received. As shown in the FIG. 3C, at step one, the UE 248C sends a signaling message by SIM1 for accessing for NTN services to NTN device 1. At step two, the UE 248C receives a reject cause from the NTN device 1. The reject cause indicates inability to provide the NTN services in the location C for three hours or until the UE 248C crosses one hundred and fifty kilometres from the location C. At step three, the UE 248C disables NTN services on SIM1 and SIM2 for three hours or till the UE 248C crosses hundred and fifty kilometres from the location C. The SIM 1 and SIM 2 belong to a location which is same as the home location of the plurality of SIMs for which the reject cause is received. Upon determining expiry of three hours or crossing hundred or fifty kilometres from the location C, at step four the UE 248C enables NTN services on the SIM1 and SIM2. At step five, the SIM2 sends a signaling message to NTN device 2 for accessing NTN services in location D. The UE 248C determines SIM2 as the primary SIM based on availability of NTN services only on SIM2 and non-availability of TN services in the location and scans for the TN coverage using SIM2 and by disabling network services on SIM1 upon successful registration with NTN device 2 for accessing the NTN services.

FIG. 3A depicts a flowchart illustrating a method 300A of power management in a UE 102 including a plurality of Subscriber Identity Modules (SIMs), in accordance with some embodiments of the present disclosure.

As illustrated in the FIG. 3A, the method 300A includes one or more blocks illustrating the method 300A of power management in a UE 102. The method 300A may be described in the general context of computer executable instructions. Generally, computer executable instructions can include routines, programs, objects, components, data structures, procedures, modules, and functions, which perform functions or implement abstract data types.

At operation 302, the method 300A includes enabling, by a UE 102, one of plurality of SIMs of UE 102 as a primary SIM when the UE 102 is in a location with no TN coverage. The primary SIM scans for availability of the TN coverage.

At operation 304, the method 300A includes disabling, by the UE 102, one or more of the plurality of SIMs of the UE 102 while the primary SIM scans for the TN coverage. The one or more of the plurality of SIMs are different from the primary SIM.

At operation 306, the method 300A includes enabling, by the UE 102, the one or more of the plurality of SIMs of the UE 102 upon detecting the availability of the TN coverage in response to scanning by the primary SIM. In an embodiment, the method 300A includes enabling, by the UE 102, the one or more of the plurality of SIMs of the UE 102 upon detecting a change in the value of the one or more of the predefined parameters.

FIG. 3B depicts a flowchart illustrating a method of power management in a UE 102 including a plurality of subscriber identity modules (SIMs), in accordance with some embodiments of the present disclosure.

As illustrated in FIG. 3B, the method 300B includes one or more blocks illustrating a method 300B for the power management in the UE 102. The method 300B may be described in the general context of computer executable instructions. Generally, computer executable instructions can include routines, programs, objects, components, data structures, procedures, modules, and functions, which perform functions or implement abstract data types.

The order in which the method 300B is described is not intended to be construed as a limitation, and any number of the described method blocks can be combined in any order to implement the method 300B. Additionally, individual blocks may be deleted from the methods without departing from the spirit and scope of the subject matter described herein. Furthermore, the method 300B can be implemented in any suitable hardware, software, firmware, or combination thereof.

At operation 308, the method 300B includes sending, by a UE 102, a signaling message for one or more of the plurality of SIMs of the UE 102 to one or more NTN networks accessible in a current location of the UE 102 for accessing NTN services.

At operation 310, the method 300B includes receiving, by the UE 102, a reject cause indicating inability to provide NTN services in the current location of the UE 102, from the one or more NTN networks, in response to the signaling for the one or more of the plurality of SIMs of the UE 102.

At operation 312, the method 300B includes disabling, by the UE 102, the one or more of the plurality of SIMs of the UE 102 in response to receiving the reject cause from the one or more NTN networks, until an expiry of at least one preset condition indicated in the corresponding reject cause. The one or more of the plurality of SIMs belong to a location which is same as the home location of the one or more of the plurality of SIMs for which the reject cause is received.

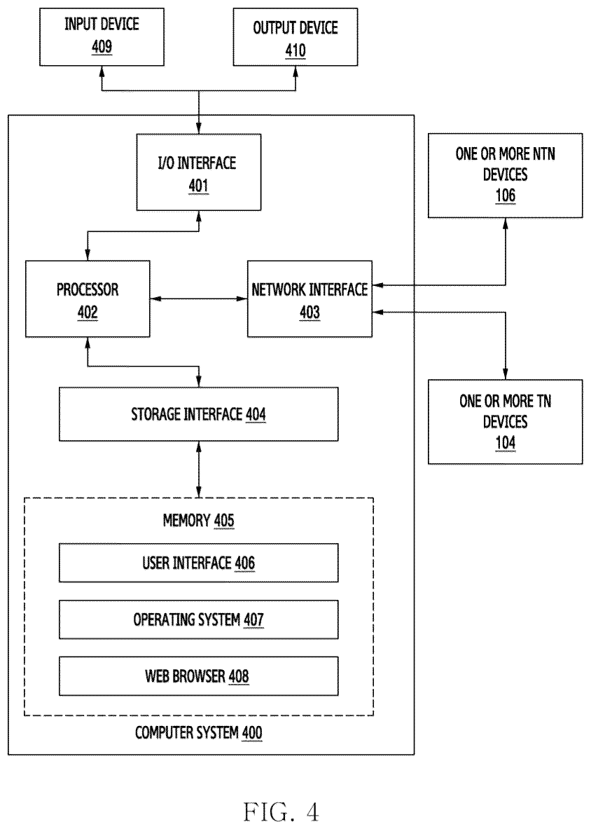

FIG. 4 illustrates a block diagram of an exemplary User Equipment (UE) 400 for implementing embodiments consistent with the present disclosure. Thus, the UE 400 may include a plurality of SIMs for power management in the UE 400. The UE 400 may comprise a Central Processing Unit 402 (also referred as “CPU” or “processor”). The processor 402 may comprise at least one data processor. The processor 402 may include specialized processing units such as integrated system (bus) controllers, memory management control units, floating point units, graphics processing units, digital signal processing units, etc. The processor 402 may be used to realize the processor 201 and 225 described in FIGS. 2A and 2B.

The processor 402 may be disposed in communication with one or more input/output (I/O) devices via I/O interface 401. The I/O interface 401 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the UE 400 may communicate with one or more I/O devices. For example, the input device 409 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 410 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 409 may include, without limitation, a direct interconnection, local area network (LAN), wide area network (WAN), wireless network (e.g., using Wireless Application Protocol), the Internet, etc. The network interface 403 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 409 includes, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 402 may be disposed in communication with a memory 405 (e.g., RAM, ROM, etc.) via a storage interface 404. The storage interface 404 may connect to memory 405 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, web browser 408 etc. In some embodiments, the UE 400 may store user/application data, such as, the data, variables, records, etc., as described in this disclosure. Such databases may be implemented as fault-tolerant, relational, scalable, secure databases such as Oracle® or Sybase®. The memory 405 may be used to realize the memory 203 described in FIG. 4. The memory 405 may be communicatively coupled to the processor 402. The memory 405 stores instructions, executable by the one or more processors 402, which, on execution, may cause the processor 402 for power management in the UE 102 including a plurality of SIMs.

The operating system 407 may facilitate resource management and operation of the UE 400. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the UE 400 may implement the web browser 408 stored program component. The web browser 408 may be a hypertext viewing application, for example MICROSOFT® INTERNET EXPLORER™, GOOGLE® CHROME™⁰, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX™, DHTML™, ADOBE® FLASH™, JAVASCRIPT™, JAVA™, Application Programming Interfaces (APIs), etc. In some embodiments, the UE 400 may implement a mail server stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the UE 400 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” may include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

The present disclosure may help the UE to save battery in remote areas where TN coverage may not be extensive. Further, in the cases when only one SIM has NTN services among the plurality of SIMs, the UE is configured to disable network services on other plurality of SIMs such that the one SIM is used for scanning the TN services which helps save battery by avoiding repetitive scans on plurality of SIMs simultaneously. Further, NTN services may be costly and UE can prioritize a SIM to avail NTN services from while disabling other SIMs resulting in cost savings. In an embodiment, the present disclosure may help UE to optimize cost savings, power management and using services effectively.

Further, the present disclosure saves substantial amount band scan time while scanning on one SIM than the band scan time consumed by existing techniques that scan using both/all SIMs. As an example, consider a dual SIM scenario, where bands supported by both SIMs are B1, B2, B4, B7, B40 and B41, and the corresponding scan times are T1, T2, T3, T4, T6 and T7 respectively. Further, consider B14 having scan time of T5 is a band supported only by SIM 1, and B18 and B66 having scan times of T8 and T9 is a band supported only by SIM 2.

The total band scan time in existing techniques where both SIMs scan is a sum of band scan time of SIM 1 and band scan time of SIM 2 i.e., [T1+T2+T3+T4+T5+T6+T7]+[T1+T2+T3+T4+T8+T6+T7+T9].

Whereas the total band scan time in the present disclosure, where any one SIM scans is a sum of band scan time of SIM 1 and the band scan time of only those bands supported by the other SIM, SIM 2 i.e., [T1+T2+T3+T4+T5+T6+T7+T8+T9].

In light of the technical advancements provided by the disclosed method and the control module, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

In some embodiments, the UE may determine the primary SIM of the device (using sensors or device history or previous/available data or using any AI/ML based mechanism) and based on the UE mobility pattern as well as the availability of the Preferred Cell/PLMN/Network at the current or the extrapolated location (i.e. the location of the device in a future time based on the mobility pattern and other factors). The device may disable and re-enable the other/secondary SIMs using the above information whenever the device moves into remote/unpopulated area or back from remote/unpopulated area respectively.

In yet another embodiment, the UE may append TN/NTN bands for all RATs from secondary/other SIMs (disabled SIMs) to the Primary SIM (Active SIM) when the UE is in Remote Area. When any TN cell is detected during scan in Primary SIM, the device would know that the device has moved to a new location with TN cells available, the device then enables the other/secondary SIMs and removes the Secondary/other SIM bands from the Primary SIM.

In yet another embodiment, when a UE receives a reject cause #78 from any NTN cell for any of the SIM card, it means the device is in a different country. In such a case, if the device does not have any NTN subscription in the preferred PLMN List (Home PLMN/UPLMN/OPLMN, etc.), the device shall disable the NTN services for the given location for the implementation specific time period.

In yet another embodiment, the device may have a settings menu/UI implementation where the User can share its preferences (for the feature to be enabled/disabled automatically or based on consent every time) as well as share the available Subscription plans/charges for TN/NTN for all the SIMs. Based on the User Inputs, the primary SIM and the feature enable/disable can be decided.

In yet another embodiment, if networks have deployed geo-fencing based approach to prevent UE from scanning NTN PLMNs in certain location, in such cases UE may use this information to select primary SIM. The SIM which is allowed to access NTN services in the present UE location may be selected as primary SIM.

In a further embodiment, the method may include selective enabling based on any user settings, device conditions (such as low battery, Heated up etc.) etc.

In yet another embodiment, the method may be extended to be used in TN and TN scenarios as well when device is in remote area with no TN coverage available.

According to an embodiment, a method of power management in a User Equipment (UE) including a plurality of Subscriber Identity Modules (SIMs), may comprise enabling, by the UE, one of plurality of SIMs as a primary SIM when the UE is in a location with no Terrestrial Network (TN) coverage, wherein the primary SIM performs a scanning for availability of the TN coverage, disabling, by the UE, one or more of the plurality of SIMs while the primary SIM scans for the TN coverage, wherein the one or more of the plurality of SIMs are different from the primary SIM, and enabling, by the UE, the one or more of the plurality of SIMs of the UE, based on detecting the availability of the TN coverage in response to the scanning performed by the primary SIM.

For example, the enabling the one of the plurality of SIMs of the UE as the primary SIM may comprise detecting, by the UE, a number of SIMs among the plurality of SIMs of the UE with a No-Terrestrial Network (NTN) only coverage, and when only one SIM among the plurality of SIMs of the UE is detected with the NTN coverage, enabling, by the UE, the SIM detected with the NTN coverage as the primary SIM.

For example, the enabling the one of the plurality of SIMs of the UE as the primary SIM may comprise detecting, by the UE, a number of SIMs among the plurality of SIMs of the UE with an NTN coverage, and when more than one SIM among the plurality of SIMs or none of the plurality of SIMs of the UE is detected with the NTN coverage, enabling, by the UE, one of the plurality of SIMs detected with the NTN coverage or no NTN coverage as the primary SIM, based on one or more predefined parameters.

For example, the disabling one or more of the plurality of SIMs of the UE while the primary SIM scans for the TN coverage may comprise, performing, by the UE, at least one of disabling, by the UE, the one or more of the plurality of SIMs other than the primary SIM, periodically, at predefined time intervals, or disabling, by the UE, the one or more of the plurality of SIMs other than the primary SIM completely until the primary SIM detects availability of the TN coverage or when there is a change in values of one or more pre-defined parameters.

For example, the one or more predefined parameters may comprise at least one of: predefined settings of the UE, user preference, services used by the UE, Artificial Intelligence or Machine Learning based predicted parameters, number of TN and NTN bands supported by each of the plurality of SIMs, NTN coverage status for each of the plurality of SIMs, type of NTN services available for each of the plurality of SIMs, TN or NTN broadcast and signaling parameters for each of the plurality of SIMs, operator deployment for TN and NTN, operator charging and subscription policy, NTN coverage unavailability period duration and start of unavailability period for each of the plurality of SIMs, NTN store and forward (S&F) support/capability history of each of the plurality of the SIMs, S&F Data quota for each of the plurality of the SIMs, S&F Data retention period for each of the plurality of the SIMs, stored data about availability of service on each of the plurality of SIMs, usage history of each of the plurality of SIMs, signal or channel conditions or data throughput status of each of the plurality of SIMs, geo-fencing data of the SIMs, and the location and mobility status and pattern of the UE.

For example, the primary SIM of the UE may scan for the TN coverage continuously, periodically, upon detecting a change in a value of one or more of the predefined parameters or upon detecting a change in the location of the UE compared to a previously detected location.

For example, the enabling the one or more of the plurality of SIMs of the UE upon detecting the availability of the TN coverage in response to scanning by the primary SIM may comprise at least one of enabling, by the UE, each of the plurality of SIMs in the UE, or enabling, by the UE, one or more SIMs of the plurality of SIMs related to which one or more pre-defined network coverage parameters are detected during scanning by the primary SIM. The one or more SIMs of the plurality of SIMs that are enabled, proceed to scan for the TN coverage or the NTN coverage.

For example, the scanning for the TN coverage may comprise scanning for an identifier corresponding to one or more predefined network coverage parameters comprising at least one of a frequency, a wavelength band, a network cell, a radio access technology (RAT), a radio access network (RAN), a network access, a network component, a network function, a network entity and a Public Land Mobile Network (PLMN) of the TN network.

According to an embodiment, a method of power management in a User Equipment (UE) including a plurality of SIMs, may comprise sending, by the UE, a signaling message for one or more of plurality of SIMs of the UE to one or more NTN networks accessible in a current location of the UE for accessing NTN services, receiving, by the UE, a reject cause indicating inability to provide the NTN services in the current location of the UE, from the one or more NTN networks, in response to the signaling for the one or more of the plurality of SIMs of the UE, and disabling, by the UE, the one or more of plurality of SIMs of the UE in response to receiving the reject cause from the one or more NTN networks, until an expiry of at least one preset condition indicated in the corresponding reject cause, wherein the one or more of the plurality of SIMs belong to a location which is same as home location of the one or more of the plurality of SIMs for which the reject cause is received.

For example, the at least one preset condition indicated in the reject cause may comprise a threshold time after which the corresponding SIM of the UE sends the signaling message, and a threshold distance to be covered from the current location of the UE after which the corresponding SIM of the UE sends the signaling message.

For example, the signaling message may be one of an access stratum signaling message or non-access stratum signaling message.

For example, the disabling the one or more of the plurality of SIMs may comprise at least one of disabling, by the UE, scanning for NTN coverage and TN coverage until an expiry of the at least one preset condition, or disabling, by the UE, scanning for the NTN coverage until an expiry of the at least one preset condition, while scanning for the TN coverage continues to be active.

For example, the method may comprise enabling, by the UE, each of the plurality of SIMs of the UE upon an expiry of the at least one preset condition indicated in the corresponding reject cause, and sending, by the UE, a signaling message for each of the plurality of SIMs of the UE to the one or more NTN networks accessible for accessing the NTN services, upon enabling each of the plurality of SIMs of the UE.

For example, the method may comprise determining, by the UE, a primary SIM from the plurality of SIMs of the UE for scanning for availability of the TN coverage upon successfully registering with one of one or more NTN devices for accessing the NTN services.

According to an embodiment, a user equipment (UE) including a plurality of subscriber identity modules (SIMs) for power management, may comprise a processor, a memory, communicatively coupled to the processor. The memory may store instructions, which, on execution, cause the processor to enable one of plurality of SIMs as a primary SIM when the UE is in a location with no Terrestrial Network (TN) coverage, wherein the primary SIM scans for availability of the TN coverage, disable one or more of the plurality of SIMs while the primary SIM scans for the TN coverage, wherein the one or more of the plurality of SIMs are different from the primary SIM, and enable the one or more of the plurality of SIMs upon detecting the availability of the TN coverage in response to scanning by the primary SIM.

For example, for enabling the one of the plurality of SIMs of the UE as the primary SIM, the processor may be configured to detect a number of SIMs among the plurality of SIMs with a Non-Terrestrial Network (NTN) only coverage, and when only one SIM among the plurality of SIMs is detected with the NTN coverage, enable the SIM detected with the NTN coverage as the primary SIM.

For example, for enabling the one of the plurality of SIMs of the UE as the primary SIM, the processor may be configured to detect a number of SIMs among the plurality of SIMs with an NTN coverage, and when more than one SIM among the plurality of SIMs or none of the plurality of SIMs is detected with the NTN coverage, enable one of the plurality of SIMs detected with the NTN coverage or no NTN coverage as the primary SIM, based on one or more predefined parameters.

For example, disabling one or more of the plurality of SIMs of the UE while the primary SIM scans for the TN coverage comprises, the processor may be configured to perform at least one of disable the one or more of the plurality of SIMs other than the primary SIM, periodically, at predefined time intervals, or disable the one or more of the plurality of SIMs other than the primary SIM completely until the primary SIM detects availability of the TN coverage or when there is a change in the values of one or more pre-defined parameters.

For example, the one or more predefined parameters comprises at least one of predefined settings of the UE, user preference, services used by the UE, artificial intelligence or machine learning based predicted parameters, number of TN and NTN bands supported by each of the plurality of SIMs, NTN coverage status for each of the plurality of SIMs, type of NTN services available for each of the plurality of SIMs, TN or NTN broadcast and signaling parameters for each of the plurality of SIMs, operator deployment for TN and NTN, operator charging and subscription policy, NTN coverage unavailability period duration and start of unavailability period for each of the plurality of SIMs, NTN store and forward (S&F) support/capability history of each of the plurality of the SIMs, S&F data quota for each of the plurality of the SIMs, S&F data retention period for each of the plurality of the SIMs, stored data about availability of service on each of the plurality of SIMs, usage history of each of the plurality of SIMs, signal or channel conditions or data throughput status of each of the plurality of SIMs, geo-fencing data of the SIMs, and the location and mobility status and pattern of the UE.

For example, the primary SIM of the UE may scan for the TN coverage continuously, periodically, upon detecting a change in a value of one or more of the predefined parameters or upon detecting a change in the location of the UE compared to a previously detected location.

For example, for enabling the one or more of the plurality of SIMs of the UE upon detecting the availability of the TN coverage in response to scanning by the primary SIM, the processor may be configured to enable each of the plurality of SIMs in the UE, or enable one or more SIMs of the plurality of SIMs related to which one or more pre-defined network coverage parameters are detected during scanning by the primary SIM. The one or more SIMs of the plurality of SIMs that are enabled, proceed to scan for the TN coverage or the NTN coverage.

For example, for scanning for the TN coverage, the processor may be configured to scan for an identifier corresponding to one or more predefined network coverage parameters comprising at least one of a frequency, a wavelength band, a network cell, a Radio Access Technology (RAT), a Radio Access Network (RAN), a network access, a network component, a network function, a network entity and a Public Land Mobile Network (PLMN) of the TN network.

According to an embodiment, a user equipment (UE) including a plurality of SIMs for power management, may comprise a processor, a memory, communicatively coupled to the processor, wherein the memory stores instructions, which, on execution, cause the processor to send a signaling message for one or more of plurality of SIMs to one or more NTN networks accessible in a current location of the UE for accessing NTN services, receive a reject cause indicating inability to provide the NTN services in the current location of the UE, from the one or more NTN networks, in response to the signaling for the one or more of the plurality of SIMs, and disable the one or more of plurality of SIMs in response to receiving the reject cause from the one or more NTN networks, until an expiry of at least one preset condition indicated in the corresponding reject cause, wherein the one or more of the plurality of SIMs belong to a location which is same as home location of the one or more of the plurality of SIMs for which the reject cause is received.

For example, the at least one preset condition indicated in the reject cause may comprise a threshold time after which the corresponding SIM of the UE sends the signaling message, and a threshold distance to be covered from the current location of the UE after which the corresponding SIM of the UE sends the signaling message.

For example, the signaling message may be one of an access stratum signaling message or non-access stratum signaling message.

For example, for disabling the one or more of the plurality of SIMs, the processor may be further configured to disable scanning for NTN coverage and TN coverage until an expiry of the at least one preset condition, or disable scanning for the NTN coverage until an expiry of the at least one preset condition while scanning for the TN coverage continues to be active.

For example, the processor may be configured to enable each of the plurality of SIMs of the UE upon an expiry of the at least one preset condition indicated in the corresponding reject cause, and send a signaling message for each of the plurality of SIMs of the UE to the one or more NTN networks accessible for accessing the NTN services, upon enabling each of the plurality of SIMs.

For example, the processor may be configured to determine a primary SIM from the plurality of SIMs of the UE for scanning for availability of the TN coverage upon successfully registering with one of one or more NTN devices for accessing the NTN services.

According to an embodiment, a method of power management in a user equipment (UE) including a plurality of subscriber identity modules (SIMs), may comprise enabling, by the UE, one of plurality of SIMs as a primary SIM based on the UE being out of Terrestrial Network (TN) coverage, wherein the primary SIM is configured to perform a scanning for availability of the TN coverage, disabling, by the UE, one or more remaining SIMs of the plurality of SIMs while the primary SIM scans for the TN coverage, and based on detection of the availability of the TN coverage by the primary SIM, enabling, by the UE, the one or more remaining SIMs.

For example, the method may comprise identifying, by the UE, at least one SIM with a No-Terrestrial Network (NTN) coverage, among the plurality of SIMs of the UE, identifying, by the UE, whether a single SIM is identified with the No-Terrestrial Network (NTN) coverage among the plurality of SIMs, and based on identifying that a single SIM is identified with the NTN coverage, enabling, by the UE, the identified SIM as the primary SIM.

For example, the method may comprise based on identifying that more than one SIM among the plurality of SIMs or none of the plurality of SIMs is detected with the NTN coverage, enabling, by the UE, one of the plurality of SIMs detected as the primary SIM, based on one or more predefined parameters.

For example, the disabling the one or more remaining SIMs while the primary SIM scans for the TN coverage may comprise, performing, by the UE, at least one of disabling, by the UE, the one or more remaining SIMs other than the primary SIM, periodically, at predefined time intervals, or disabling, by the UE, the one or more remaining SIMs other than the primary SIM completely until the primary SIM detects availability of the TN coverage or when at least one of the one or more pre-defined parameters is changed.

For example, the one or more predefined parameters may comprise at least one of: predefined settings of the UE, user preference, services used by the UE, artificial intelligence or machine learning based predicted parameters, number of TN and NTN bands supported by each of the plurality of SIMs, NTN coverage status for each of the plurality of SIMs, type of NTN services available for each of the plurality of SIMs, TN or NTN broadcast and signaling parameters for each of the plurality of SIMs, operator deployment for TN and NTN, operator charging and subscription policy, NTN coverage unavailability period duration and start of unavailability period for each of the plurality of SIMs, NTN store and forward (S&F) support/capability history of each of the plurality of the SIMs, S&F data quota for each of the plurality of the SIMs, S&F data retention period for each of the plurality of the SIMs, stored data about availability of service on each of the plurality of SIMs, usage history of each of the plurality of SIMs, signal or channel conditions or data throughput status of each of the plurality of SIMs, geo-fencing data of the SIMs, and the location and mobility status and pattern of the UE.

For example, the primary SIM of the UE may scan for the TN coverage continuously, periodically, upon detecting a change in a value of one or more of the predefined parameters or upon detecting a change in the location of the UE compared to a previously detected location.

For example, the enabling the one or more remaining SIMs may comprise enabling, by the UE, one or more remaining SIMs based on one or more pre-defined network coverage parameters being detected during scanning by the primary SIM. After the one or more remaining SIMs are enabled by the UE, the one or more remaining SIMs may be configured to scan for the TN coverage or the NTN coverage.

For example, the scanning for the TN coverage may comprise scanning for an identifier corresponding to one or more predefined network coverage parameters comprising at least one of a frequency, a wavelength band, a network cell, a radio access technology (RAT), a radio access network (RAN), a network access, a network component, a network function, a network entity and a public land mobile network (PLMN) of the TN network.

According to an embodiment, a method of power management in a user equipment (UE) including a plurality of SIMs, may comprise sending, by the UE, a signaling message for one or more of plurality of SIMs of the UE to one or more NTN networks accessible in a current location of the UE for accessing NTN services, receiving, by the UE, a reject cause indicating inability to provide the NTN services in the current location of the UE, from the one or more NTN networks, in response to the signaling for the one or more of the plurality of SIMs of the UE, and disabling, by the UE, the one or more of plurality of SIMs of the UE in response to receiving the reject cause from the one or more NTN networks, until an expiry of at least one preset condition indicated in the corresponding reject cause. The one or more of the plurality of SIMs may belong to a location which is same as home location of the one or more of the plurality of SIMs for which the reject cause is received.

For example, the at least one preset condition indicated in the reject cause may comprise a threshold time after which the corresponding SIM of the UE sends the signaling message, and a threshold distance to be covered from the current location of the UE after which the corresponding SIM of the UE sends the signaling message.

For example, the signaling message may be one of an access stratum signaling message or non-access stratum signaling message.

For example, the disabling the one or more of the plurality of SIMs may comprise at least one of disabling, by the UE, scanning for NTN coverage and TN coverage until an expiry of the at least one preset condition, or disabling, by the UE, scanning for the NTN coverage until an expiry of the at least one preset condition, while scanning for the TN coverage continues to be active.

For example, the method may comprise enabling, by the UE, each of the plurality of SIMs of the UE upon an expiry of the at least one preset condition indicated in the corresponding reject cause, and sending, by the UE, a signaling message for each of the plurality of SIMs of the UE to the one or more NTN networks accessible for accessing the NTN services, upon enabling each of the plurality of SIMs of the UE.

For example, the method may comprise determining, by the UE, a primary SIM from the plurality of SIMs of the UE for scanning for availability of the TN coverage upon successfully registering with one of one or more NTN devices for accessing the NTN services.

According to an embodiment, a user equipment (UE) including a plurality of subscriber identity modules (SIMs) for power management, may comprise at least one processor including processing circuitry, a memory, including one or more storage media, storing instructions. The instructions, when executed by the at least one processor individually or collectively, may cause the UE to enable, by the UE, one of plurality of SIMs as a primary SIM based on the UE being out of Terrestrial Network (TN) coverage, wherein the primary SIM is configured to perform a scanning for availability of the TN coverage, disable, by the UE, one or more remaining SIMs of the plurality of SIMs while the primary SIM scans for the TN coverage, and based on detection of the availability of the TN coverage by the primary SIM, enable, by the UE, the one or more remaining SIMs.

For example, the instructions, when executed by the at least one processor individually or collectively, may cause the UE to identify, by the UE, at least one SIM with a No-Terrestrial Network (NTN) coverage, among the plurality of SIMs of the UE, identify, by the UE, whether a single SIM is identified with the No-Terrestrial Network (NTN) coverage among the plurality of SIMs, and based on identifying that a single SIM is identified with the NTN coverage, enable, by the UE, the identified SIM as the primary SIM.

For example, the instructions, when executed by the at least one processor individually or collectively, cause the UE to based on identifying that more than one SIM among the plurality of SIMs or none of the plurality of SIMs is detected with the NTN coverage, enable, by the UE, one of the plurality of SIMs detected as the primary SIM, based on one or more predefined parameters.

For example, the instructions, when executed by the at least one processor individually or collectively, may cause the UE to perform at least one of disabling the one or more remaining SIMs other than the primary SIM, periodically, at predefined time intervals, or disabling the one or more remaining SIMs other than the primary SIM completely until the primary SIM detects availability of the TN coverage or when at least one of the one or more pre-defined parameters is changed.

For example, the one or more predefined parameters may comprise at least one of: predefined settings of the UE, user preference, services used by the UE, Artificial Intelligence or Machine Learning based predicted parameters, number of TN and NTN bands supported by each of the plurality of SIMs, NTN coverage status for each of the plurality of SIMs, type of NTN services available for each of the plurality of SIMs, TN or NTN broadcast and signaling parameters for each of the plurality of SIMs, operator deployment for TN and NTN, operator charging and subscription policy, NTN coverage unavailability period duration and start of unavailability period for each of the plurality of SIMs, NTN store and forward (S&F) support/capability history of each of the plurality of the SIMs, S&F Data quota for each of the plurality of the SIMs, S&F Data retention period for each of the plurality of the SIMs, stored data about availability of service on each of the plurality of SIMs, usage history of each of the plurality of SIMs, signal or channel conditions or data throughput status of each of the plurality of SIMs, geo-fencing data of the SIMs, and the location and mobility status and pattern of the UE.

For example, the primary SIM of the UE may scan for the TN coverage continuously, periodically, upon detecting a change in a value of one or more of the predefined parameters or upon detecting a change in the location of the UE compared to a previously detected location.

The terms “an embodiment”, “embodiment”, “embodiments”, “the embodiment”, “the embodiments”, “one or more embodiments”, “some embodiments”, and “one embodiment” mean “one or more (but not all) embodiments of the present disclosure(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the present disclosure.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of the present disclosure need not include the device itself.

Finally, the language used in the specification has been principally selected for readability and instructional purposes, and it may not have been selected to delineate or circumscribe the inventive subject matter. It is, therefore, intended that the scope of the present disclosure be limited not by this detailed description, but rather by any claims that issue on an application based here on. Accordingly, the embodiments of the present disclosure are intended to be illustrative, but not limiting, of the scope of the present disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of power management in a user equipment (UE) including a plurality of subscriber identity modules (SIMs), the method comprising:
enabling, by the UE, one of plurality of SIMs as a primary SIM based on the UE being out of Terrestrial Network (TN) coverage, wherein the primary SIM is configured to perform a scanning for availability of the TN coverage;
disabling, by the UE, one or more remaining SIMs of the plurality of SIMs while the primary SIM scans for the TN coverage; and
based on detection of the availability of the TN coverage by the primary SIM, enabling, by the UE, the one or more remaining SIMs.

2. The method of claim 1, wherein the method comprises:
identifying, by the UE, at least one SIM with a No-Terrestrial Network (NTN) coverage, among the plurality of SIMs of the UE;
identifying, by the UE, whether a single SIM is identified with the No-Terrestrial Network (NTN) coverage among the plurality of SIMs; and
based on identifying that a single SIM is identified with the NTN coverage, enabling, by the UE, the identified SIM as the primary SIM.

3. The method of claim 2, wherein the method comprises:
based on identifying that more than one SIM among the plurality of SIMs or none of the plurality of SIMs is detected with the NTN coverage, enabling, by the UE, one of the plurality of SIMs detected as the primary SIM, based on one or more predefined parameters.

4. The method of claim 3, wherein the disabling the one or more remaining SIMs while the primary SIM scans for the TN coverage comprises, performing, by the UE, at least one of:
disabling, by the UE, the one or more remaining SIMs other than the primary SIM, periodically, at predefined time intervals, or
disabling, by the UE, the one or more remaining SIMs other than the primary SIM completely until the primary SIM detects availability of the TN coverage or when at least one of the one or more pre-defined parameters is changed.

5. The method of claim 3, wherein the one or more predefined parameters comprise at least one of: predefined settings of the UE, user preference, services used by the UE, artificial intelligence or machine learning based predicted parameters, number of TN and NTN bands supported by each of the plurality of SIMs, NTN coverage status for each of the plurality of SIMs, type of NTN services available for each of the plurality of SIMs, TN or NTN broadcast and signaling parameters for each of the plurality of SIMs, operator deployment for TN and NTN, operator charging and subscription policy, NTN coverage unavailability period duration and start of unavailability period for each of the plurality of SIMs, NTN store and forward (S&F) support/capability history of each of the plurality of the SIMs, S&F data quota for each of the plurality of the SIMs, S&F data retention period for each of the plurality of the SIMs, stored data about availability of service on each of the plurality of SIMs, usage history of each of the plurality of SIMs, signal or channel conditions or data throughput status of each of the plurality of SIMs, geo-fencing data of the SIMs, and the location and mobility status and pattern of the UE.

6. The method of claim 3, wherein the primary SIM of the UE scans for the TN coverage continuously, periodically, upon detecting a change in at least one of the one or more of the predefined parameters or upon detecting a change in the location of the UE compared to a previously detected location.

7. The method of claim 1, wherein the enabling the one or more remaining SIMs comprises:
enabling, by the UE, one or more remaining SIMs based on one or more pre-defined network coverage parameters being detected during scanning by the primary SIM,
wherein, after the one or more remaining SIMs are enabled by the UE, the one or more remaining SIMs are configured to scan for the TN coverage or the NTN coverage.

8. The method of claim 1, wherein the scanning for the TN coverage comprises scanning for an identifier corresponding to one or more predefined network coverage parameters comprising at least one of a frequency, a wavelength band, a network cell, a Radio Access Technology (RAT), a Radio Access Network (RAN), a network access, a network component, a network function, a network entity and a Public Land Mobile Network (PLMN) of the TN network.

9. A method of power management in a User Equipment (UE) including a plurality of SIMs, the method comprising:
sending, by the UE, a signaling message for one or more of plurality of SIMs of the UE to one or more NTN networks accessible in a current location of the UE for accessing NTN services;
receiving, by the UE, a reject cause indicating inability to provide the NTN services in the current location of the UE, from the one or more NTN networks, in response to the signaling for the one or more of the plurality of SIMs of the UE; and
disabling, by the UE, the one or more of plurality of SIMs of the UE in response to receiving the reject cause from the one or more NTN networks, until an expiry of at least one preset condition indicated in the corresponding reject cause, wherein the one or more of the plurality of SIMs belong to a location which is same as home location of the one or more of the plurality of SIMs for which the reject cause is received.

10. The method of claim 9, wherein the at least one preset condition indicated in the reject cause comprises a threshold time after which the corresponding SIM of the UE sends the signaling message, and a threshold distance to be covered from the current location of the UE after which the corresponding SIM of the UE sends the signaling message.

11. The method of claim 9, wherein the signaling message is one of an access stratum signaling message or non-access stratum signaling message.

12. The method of claim 9, wherein the disabling the one or more of the plurality of SIMs comprises at least one of:
disabling, by the UE, scanning for NTN coverage and TN coverage until an expiry of the at least one preset condition, or
disabling, by the UE, scanning for the NTN coverage until an expiry of the at least one preset condition, while scanning for the TN coverage continues to be active.

13. The method of claim 9 further comprises:
enabling, by the UE, each of the plurality of SIMs of the UE upon an expiry of the at least one preset condition indicated in the corresponding reject cause; and
sending, by the UE, a signaling message for each of the plurality of SIMs of the UE to the one or more NTN networks accessible for accessing the NTN services, upon enabling each of the plurality of SIMs of the UE.

14. The method of claim 9 further comprises determining, by the UE, a primary SIM from the plurality of SIMs of the UE for scanning for availability of the TN coverage upon successfully registering with one of one or more NTN devices for accessing the NTN services.

15. A User Equipment (UE) including a plurality of Subscriber Identity Modules (SIMs) for power management, the UE comprising:
at least one processor including processing circuitry;
a memory, including one or more storage media, storing instructions,
wherein the instructions, when executed by the at least one processor individually or collectively, cause the UE to:
enable, by the UE, one of plurality of SIMs as a primary SIM based on the UE being out of Terrestrial Network (TN) coverage, wherein the primary SIM is configured to perform a scanning for availability of the TN coverage;
disable, by the UE, one or more remaining SIMs of the plurality of SIMs while the primary SIM scans for the TN coverage; and
based on detection of the availability of the TN coverage by the primary SIM, enable, by the UE, the one or more remaining SIMs.

16. The UE of claim 15, wherein the instructions, when executed by the at least one processor individually or collectively, cause the UE to:
identify, by the UE, at least one SIM with a No-Terrestrial Network (NTN) coverage, among the plurality of SIMs of the UE;
identify, by the UE, whether a single SIM is identified with the No-Terrestrial Network (NTN) coverage among the plurality of SIMs; and
based on identifying that a single SIM is identified with the NTN coverage, enable, by the UE, the identified SIM as the primary SIM.

17. The UE of claim 16, wherein the instructions, when executed by the at least one processor individually or collectively, cause the UE to:
based on identifying that more than one SIM among the plurality of SIMs or none of the plurality of SIMs is detected with the NTN coverage, enable, by the UE, one of the plurality of SIMs detected as the primary SIM, based on one or more predefined parameters.

18. The UE of claim 17, wherein the instructions, when executed by the at least one processor individually or collectively, cause the UE to perform at least one of:
disabling the one or more remaining SIMs other than the primary SIM, periodically, at predefined time intervals; or
disabling the one or more remaining SIMs other than the primary SIM completely until the primary SIM detects availability of the TN coverage or when at least one of the one or more pre-defined parameters is changed.

19. The UE of claim 15, wherein the one or more predefined parameters comprises at least one of: predefined settings of the UE, user preference, services used by the UE, artificial intelligence or machine learning based predicted parameters, number of TN and NTN bands supported by each of the plurality of SIMs, NTN coverage status for each of the plurality of SIMs, type of NTN services available for each of the plurality of SIMs, TN or NTN broadcast and signaling parameters for each of the plurality of SIMs, operator deployment for TN and NTN, operator charging and subscription policy, NTN coverage unavailability period duration and start of unavailability period for each of the plurality of SIMs, NTN store and forward (S&F) support/capability history of each of the plurality of the SIMs, S&F data quota for each of the plurality of the SIMs, S&F data retention period for each of the plurality of the SIMs, stored data about availability of service on each of the plurality of SIMs, usage history of each of the plurality of SIMs, signal or channel conditions or data throughput status of each of the plurality of SIMs, geo-fencing data of the SIMs, and the location and mobility status and pattern of the UE.

20. The UE of claim 17, wherein the primary SIM of the UE scans for the TN coverage continuously, periodically, upon detecting a change in at least one of the one or more of the predefined parameters or upon detecting a change in the location of the UE compared to a previously detected location.
